(19) United States
(12) Patent Application Publication
(10) Pub. No.: US 2026/0244732 A1
(43) Pub. Date: Aug. 20, 2026

(54) Time of Time_Sovereign Time Certification and Behavioral Currency System

(71) Applicant: FURONG BEI, SAN GABRIEL, CA (US)

(72) Inventor: FURONG BEI, SAN GABRIEL, CA (US)

(21) Appl. No.: 19/174,950

(22) Filed: Apr. 10, 2025

(51) Int. Cl. G06F 21/45; G06F 1/14

(52) U.S. Cl. CPC G06F 21/45; G06F 1/14

(57) ABSTRACT

A Time of Time system generates a BEI composite time signature from a Time of Time anchor, a behavior vector, and an identity, domain, or non-domain identifier context. A BEI signal fusion engine receives biometric, behavioral, contextual, device, location, communication, service, or institutional proof signals. A verifier applies behavioral proof, SceneKey context, privacy filtering, zero-knowledge verification, and entropy anti-spoofing to determine signature validity. A BEIMINT conditioned issuance module generates or updates a time-certified digital asset, including a TimeCoin or TimeCurrency unit as a non-limiting example, only after validation. The asset is stored in a Time Wallet or TimeVault linked to BID, DID, ReadName, or TimeID records and synchronized through a Time Sync API and distributed TimeNodes. Optional index, exchange, licensing, and asset-package endpoints may use the verified signature while preserving privacy and human time certification for personal, family, institutional, regional, and international use.

### CROSS-REFERENCE TO RELATED APPLICATIONS

This application relates to subject matter concerning time-based certification, behavioral-economic identity, Time-of-Time anchoring, time currency, conditioned issuance, time wallet storage, domain-linked and non-domain identity, time indexing, and distributed time synchronization, including systems that may interoperate with BEI, TimeCurrency, BEIMINT, TimeDomain, TimeRing, TimeWallet, TimeIndex, and TimeSync technologies.

### TECHNICAL FIELD

The present disclosure relates to computer-implemented time-certification systems, behavioral identity verification, cryptographic signature generation, privacy-preserving proof systems, distributed synchronization, secure storage nodes, digital identity, wallet infrastructure, and conditional issuance of certified digital data units. More particularly, the disclosure relates to a Time of Time and BEI architecture for generating a BEI composite time signature from a time anchor, a behavior vector, and an identity-linked domain or non-domain context, and for conditionally issuing a time-certified digital asset only after verification of behavioral proof and signature validity.

The disclosure further relates to standards-compatible interfaces by which Time Signatures, time-certified assets, identity records, wallet records, and synchronization records may be queried, verified, indexed, or integrated with domain-linked and non-domain identifiers, decentralized identifiers, verifiable credentials, hardware security modules, trusted execution environments, edge nodes, wallets, ledgers, exchange endpoints, index endpoints, healthcare systems, educational systems, service systems, family systems, regional systems, national systems, and international institutional systems.

### BACKGROUND

### Human Time, Value, and the Missing Technical Standard

Human societies across civilizations have long recognized that time has value. Across cultures, languages, and historical periods, human beings have expressed the idea that time is precious, non-recoverable, and often more valuable than material wealth. Expressions such as “time is money” and similar proverbs in many languages reflect a universal human recognition that lived time, labor time, care time, learning time, health time, communication time, and contribution time carry value. However, prior financial, identity, clock, ledger, and digital systems have not provided a technical pathway for certifying a person's life-time, behavioral time, service time, care time, labor time, learning time, health time, communication time, or contribution time as a cryptographically verifiable, privacy-preserving, synchronizable, inheritable, indexable, licensable, and transferable digital record.

Existing clocks can measure physical time, and network time protocols can synchronize machines. Existing identity systems can identify accounts, persons, devices, or organizations. Existing blockchain ledgers can timestamp transactions. Existing wallets can store credentials or assets. Existing time-banking systems can record service hours. Existing biometric systems can authenticate identity. These systems, however, generally operate as separate components. They do not provide an integrated root standard for binding a Time-of-Time anchor, a behavior vector, and an identity-linked domain or non-domain context into a BEI composite time signature that gates conditional issuance of a time-certified digital asset and distributed synchronization through TimeNodes.

A technical problem exists when a distributed system must determine whether a claimed human time event is authentic, belongs to a particular behavioral-economic identity, occurred within a relevant time context, corresponds to a real behavior rather than an artificial or replayed signal, and can be safely certified without exposing raw personal, biometric, emotional, health, service, or behavioral data. A further problem exists when downstream wallets, indexes, exchanges, licensing systems, healthcare systems, family systems, industry systems, government systems, or international institutional systems need to verify time-based records without trusting a single central database.

The present disclosure addresses these technical problems by defining a BEI Time Standard root infrastructure. The system converts human life-time and behavioral-economic identity time into a BEI composite time signature, verifies the signature using behavioral proof, privacy filtering, zero-knowledge verification, and entropy anti-spoofing, and conditionally issues a time-certified digital asset through BEIMINT for secure storage, synchronization, indexing, exchange validation, licensing, inheritance, audit, or asset-package integration.

### Historical, Linguistic, and Technical Origin of Bei and Time of Time

The term BEI may refer to Behavioral-Economic Identity, Behavior-Economy-Identity, or a behavior-based economic identity framework. In Chinese, the character Bei may be associated historically with shells and early forms of money, and appears in many characters related to wealth, value, exchange, storage, debt, assets, accounts, and commerce. The inventor's surname Bei also shares the same Chinese character. This linguistic and historical correspondence provides one non-limiting background for the BEI naming framework. The technical scope of BEI is not limited to any language, surname, character, culture, or symbolic meaning.

The Time of Time concept provides a technical standard for converting life-time, living time, behavioral time, identity time, service time, care time, labor time, learning time, health time, communication time, and contribution time into verifiable Time Signatures and time-certified assets. In certain embodiments, a Time-of-Time anchor may originate from an earliest detectable life-related event, such as fetal movement, a birth-related signal, a biometric life signal, an identity-initiation event, a first institutional enrollment, a first wallet registration, a first verified behavior, a first service event, or another life-origin or behavior-origin event. Fetal movement is one non-limiting example of life-origin time and is not required in every embodiment.

In certain non-limiting embodiments, a historically prepared organic, green, cellular, hive-like, or multi-system domain-name and identifier fabric may serve as a deployment environment for the BEI Time-of-Time system. Such infrastructure may include domains, subdomains, application gateways, wallet endpoints, minting endpoints, identity endpoints, time-unit endpoints, index endpoints, exchange endpoints, healthcare endpoints, emergency endpoints, educational endpoints, family endpoints, industry endpoints, regional endpoints, national endpoints, international endpoints, and ecosystem endpoints. The use of domain names is illustrative only; the invention may be practiced without domain names using decentralized identifiers, public keys, wallet addresses, device identifiers, secure elements, HSM-bound identifiers, TEE attestation reports, verifiable credential references, OIDC identifiers, QR codes, NFC tags, local endpoints, embedded identifiers, offline keys, edge nodes, or other identifiers.

### SUMMARY OF THE BEI TIME STANDARD

The present invention provides a computer-implemented BEI Time-of-Time root infrastructure comprising a Time-of-Time Anchor module, a BEI signal fusion engine, a BEI composite time signature generator, a behavioral proof verifier, a privacy and zero-knowledge verification module, an entropy anti-spoofing module, a BEIMINT conditioned issuance module, a Time Wallet or TimeVault secure storage node, an identity binding module, and a Time Sync API coupled with distributed TimeNodes.

The BEI signal fusion engine receives biometric, behavioral, contextual, device-based, location-based, communication-session, service-event, care-event, health-event, learning-event, labor-event, institutional proof, or contribution signals. Raw signals may be filtered, sampled, normalized, windowed, vectorized, and scored to generate a Behavior Vector. An identity, domain, or identifier context may be generated from one or more of a BID, DID, ReadName, TimeID, domain name, subdomain, public key, wallet address, device identifier, verifiable credential, HSM identifier, TEE attestation report, OIDC identifier, QR code, NFC tag, offline key, API endpoint, blockchain address, smart contract address, edge node identifier, or other machine-readable or human-readable identifier.

A BEI Composite Time Signature, also referred to as BEI-TSIG in certain embodiments, is generated by cryptographically combining at least a Time-of-Time Anchor, a Behavior Vector, and an identity/domain/identifier context. In certain embodiments, the BEI-TSIG may be represented as H(Time-of-Time Anchor∥Behavior Vector∥Identity/Domain/Identifier Context∥Device/Proof Attestation∥Nonce), where H denotes a cryptographic hash or signature function. The signature may be verified using SceneKey context, behavioral proof, privacy filtering, zero-knowledge verification, entropy anti-spoofing, replay prevention, and synthetic behavior detection.

A BEIMINT conditioned issuance module generates, updates, transfers, accumulates, or certifies a time-certified digital asset only after validation of the BEI Composite Time Signature and the behavioral proof condition. TimeCoin, TimeCurrency, BEI Currency, BI Currency, and similar terms are non-limiting examples of time-certified digital assets or certified time-value data units. The asset may be stored in a Time Wallet or TimeVault with metadata, lifecycle permissions, beneficiary rules, inheritance rules, rights metadata, contribution scores, audit references, and Time Sync records.

### Definitions

The following definitions are provided to support consistent interpretation of this disclosure. These definitions describe non-limiting technical meanings unless a claim expressly requires a narrower meaning.

Time of Time or TOTBEI: a foundational temporal standard and computational anchor for converting human life-time, living time, behavioral time, identity time, service time, care time, labor time, learning time, health time, communication time, or contribution time into verifiable Time Signatures and time-certified digital assets.

BEI or Behavioral-Economic Identity: a behavior-based economic identity framework in which a subject's verified time events, behaviors, services, contributions, identity credentials, domain-linked or non-domain identifiers, wallet records, synchronization records, and index records are associated with Time Signatures, TimeCoins, Time Wallets, TimeNodes, or index outputs.

BEI Time Standard: a technical standard that associates Time-of-Time anchors, BEI identities, BEI Composite Time Signatures, behavioral proof, BEIMINT conditioned issuance, Time Wallet storage, Time Sync APIs, TimeNodes, and optional index, exchange, licensing, or asset-package endpoints.

Time-of-Time Anchor: a metrical temporal reference for a time event, including a life-origin event, identity-initiation event, behavioral event, service event, care event, labor event, learning event, communication event, health event, contribution event, time-unit event, or other event used to certify a time record.

BEI Composite Time Signature or BEI-TSIG: a cryptographic representation generated from at least a time component, a behavior component, and an identity-linked, domain-linked, or identifier-linked context component.

Behavior Vector: a structured data representation generated from one or more behavioral, biometric, contextual, device, location, service, care, health, learning, labor, communication, institutional, or contribution signals.

SceneKey or Behavioral Proof: a verification condition or proof structure that confirms an event occurred in a relevant time, behavior, environment, identity, device, location, domain, service, or institutional context.

Privacy Filter: a technical process that permits verification of a time event or behavioral proof while masking, abstracting, encrypting, redacting, hashing, or otherwise protecting raw personal, biometric, behavioral, emotional, health, or service content.

Zero-Knowledge Verification: a privacy-preserving verification operation that verifies a predicate concerning a time event, signature, behavior vector, identity context, or asset state without exposing the underlying raw data.

Entropy Anti-Spoofing: a process that evaluates consistency, randomness, density, timing, ordering, device attestation, location, behavior sequence, or identity-context features to detect replay, duplicate issuance, AI-generated behavior, synthetic behavior, or inconsistent signals.

BEIMINT: a non-limiting conditioned cryptographic issuance process by which a verified BEI Composite Time Signature is used to generate, update, transfer, accumulate, or certify a time-certified digital asset.

TimeCoin, TimeCurrency, BEI Currency, or BI Currency: non-limiting examples of a time-certified digital asset, certified data unit, or time-value record generated from a verified Time Signature and stored or synchronized according to the system.

Time Wallet or TimeVault: a secure storage node, wallet, vault, ledger compartment, account, or data structure that stores Time Signatures, time-certified assets, identity references, lifecycle metadata, beneficiary permissions, inheritance rules, audit references, rights metadata, contribution scores, or synchronization records.

BID, DID, ReadName, or TimeID: non-limiting identity mechanisms for binding a user, family, institution, device, service, region, or organization to time records, signatures, assets, wallets, endpoints, or TimeNodes.

Time Sync API and TimeNodes: interfaces and distributed nodes configured to synchronize, query, verify, audit, route, validate, index, or report Time Signatures, assets, wallet records, identity bindings, or verification states.

Value Aggregation Vault: a wallet, vault, domain node, asset pool, or data structure that aggregates TimeCoins, Time Signature records, identity credentials, domain-linked assets, contribution records, index outputs, wallet records, or exchange records associated with a user, family, institution, region, industry, or service domain.

Undeveloped Behavioral-Economic Namespace: a domain, subdomain, service category, industry sector, geographic region, time interval, family class, identity class, or contribution category that may be activated by generating Time Signatures, issuing time-certified assets, synchronizing TimeNodes, or linking the namespace to a BID, DID, ReadName, or TimeID identity.

| Term | Non-limiting technical implementation |
|---|---|
| Time-of-Time | {anchorId, anchorType, timeSource, startTime, |
| Anchor | endTime, confidence, sourceAttestation, |
| | privacyMask} |
| Behavior Vector | {featureType, valueHash, timeWindow, |
| | confidence, sourceAttestation, policyReference} |
| Identity Context | {identityRef, identifierType, credentialRef, |
| | walletRef, deviceAttestation, roleMetadata, |
| | privacyScope} |
| BEI-TSIG | H(TimeAnchor \|\| BehaviorVector \|\| |
| | IdentityContext \|\| ProofAttestation \|\| Nonce) |
| Time-certified | {assetId, signatureRef, ownerRef, walletRef, |
| Digital Asset | usageCategory, lifecycleState, syncStatus} |
| Time Sync | {signatureId, assetId, verifierId, purpose, |
| Verification | privacyScope} → {status, confidence, auditRef} |

### System Overview

In one embodiment, a system comprises a Time-of-Time Anchor module, a BEI signal fusion engine, a behavior vector generator, an identity/domain/identifier context generator, a composite time signature generator, a behavioral proof verifier, an entropy anti-spoofing module, a privacy or zero-knowledge verification module, a BEIMINT conditioned issuance module, a secure storage node, an identity binding module, and a Time Sync API. The modules may execute on one or more servers, mobile devices, edge nodes, wearable devices, embedded devices, hardware security modules, trusted execution environments, wallets, local networks, public networks, private networks, distributed ledgers, or hybrid computing environments.

The system may be implemented as an open technical standard, private deployment, enterprise deployment, family deployment, healthcare deployment, educational deployment, regional deployment, national deployment, international institutional deployment, or mixed deployment. It may operate with domain names, without domain names, with decentralized identifiers, with public keys, with wallet addresses, with devices, with QR or NFC tags, with offline keys, with local endpoints, or with any other identifier capable of linking a time event, behavior proof, identity record, storage record, or synchronization record.

The root layer may generate BEI Composite Time Signatures and issue time-certified assets. Downstream or external layers may provide valuation metering, domain routing, financial clearing, exchange listing, index generation, payment settlement, licensing, regulatory reporting, or asset-package integration. Such downstream layers are optional and are not required for practicing the root time-certification system.

### Time-of-Time Anchor Layer

The Time-of-Time Anchor module assigns or derives a temporal reference for a time event. Unlike a conventional server timestamp alone, the Time-of-Time Anchor may be associated with a life-origin time, identity-initiation time, behavior-origin time, service event time, care event time, learning event time, health event time, communication event time, contribution event time, time-unit event, local clock signal, network time signal, distributed ledger timestamp, device clock, edge node time, institutional timestamp, or combinations thereof.

In certain embodiments, a life-origin time includes an earliest detectable life-related event, including fetal movement, a birth-related signal, an initial biometric life signal, an institutional birth record, or another event that indicates commencement of a human life-time record. In other embodiments, the anchor may begin from account creation, wallet generation, device enrollment, identity credential issuance, service enrollment, family registration, institutional registration, or first verified behavior. The system is not limited to a fetal event, and any suitable temporal reference may be used.

The anchor may be represented as a tuple including an anchor identifier, event type, time source, time interval, confidence score, source signature, node identifier, and optional privacy mask. A non-limiting schema may include {anchorId, anchorType, timeSource, startTime, endTime, confidence, sourceAttestation, privacyMask, nodeReference}. This data may be hashed, signed, encrypted, selectively disclosed, or zero-knowledge proven as part of a BEI Composite Time Signature.

### BID, DID, ReadName, and TimeID Identity Layer

The identity layer binds a time event to a subject, device, family, institution, organization, region, industry, service, or node. The identity layer may use a BID, DID, ReadName, TimeID, domain-linked identifier, subdomain identifier, public key, wallet address, verifiable credential, OIDC identifier, HSM-bound identifier, TEE attestation report, device identifier, secure element identifier, QR code, NFC tag, offline key, local endpoint, edge node identifier, or other identifier.

A BID may be used as a behavior-linked identity record. A DID may provide standards-compatible decentralized identity. A ReadName may provide a human-readable or domain-linked identity. A TimeID may provide a time-based identity reference. These mechanisms may be combined or substituted. The claims are not limited to any one identity protocol.

An identity context may include an identity reference, credential issuer, wallet reference, domain or non-domain endpoint, device attestation, credential expiration state, role metadata, profession metadata, family metadata, institutional metadata, service role, location scope, consent state, and privacy policy. The identity context may be stored directly, hashed, tokenized, or represented as a verifiable credential reference.

### BEI Signal Fusion Engine and Behavior Vector Generation

The BEI signal fusion engine receives raw signals relating to a time event. Signals may include heartbeat, respiration, gaze, presence, touch, motion, acceleration, gyroscope, keystroke cadence, communication metadata, device telemetry, location data, navigation session metadata, service transaction metadata, institutional proof, professional credential proof, educational attendance proof, healthcare event proof, care event proof, labor event proof, and contribution event proof.

To avoid functional claiming, the system may perform a deterministic signal normalization process. In one embodiment, raw signals are associated with a sampling window, filtered to remove noise, normalized to a common scale, timestamp-aligned, assigned a confidence score, and transformed into a Behavior Vector. A raw accelerometer signal may be transformed into a motion feature vector; a communication session may be transformed into a message-event vector; an institutional service record may be transformed into a service-proof vector; and a biometric trace may be transformed into a privacy-filtered biometric feature vector.

A non-limiting normalization algorithm includes: receive raw signal S from source i; verify source attestation A_i; map S into time window W; apply noise filter F(S); compute normalized feature vector V_i=Normalize (F(S), W, sourcePolicy); compute confidence C_i; append {featureType, valueHash, timeWindow, confidence, sourceAttestation} to the Behavior Vector. The Behavior Vector may then be used as an input to BEI-TSIG generation without requiring exposure of raw signals.

### BEI Composite Time Signature Generation

A BEI Composite Time Signature is a cryptographic representation generated from a Time-of-Time Anchor, a Behavior Vector, and an identity-linked, domain-linked, or identifier-linked context component. In one embodiment, the signature is generated according to: BEI-TSIG=H(TA∥BV∥IC∥PA∥N), where TA is a Time-of-Time Anchor, BV is a Behavior Vector, IC is an identity/domain/identifier context, PA is a device or proof attestation, Nis a nonce, and His a cryptographic hash or signature function.

The signature generator may operate in a deterministic, privacy-preserving, or zero-knowledge-compatible manner. The output may include a signature identifier, algorithm identifier, anchor reference, behavior vector commitment, context commitment, attestation reference, nonce, time window, verification policy, issuer node, and optional zero-knowledge proof reference. The signature may be non-fungible with respect to a particular time event because the behavior vector and context component are event-specific.

The composite structure distinguishes the system from a conventional timestamp. A conventional timestamp may certify when a data object existed. A BEI Composite Time Signature certifies a fused time, behavior, identity, context, and proof structure that may serve as a gate condition for issuance, storage, synchronization, audit, index, exchange validation, or licensing.

### Non-Limiting Pseudocode:

```
  function generate_BEI_TSIG(rawSignals, identityInputs, timeInputs):
    TA = derive_time_of_time_anchor(timeInputs)
    BV = normalize_and_vectorize(rawSignals)
    IC = build_identity_domain_identifier_context(identityInputs)
    PA = collect_device_or_proof_attestations(rawSignals, identityInputs)
    N = generate_nonce(TA, IC)
    commitment = concatenate(TA, BV, IC, PA, N)
    TSIG = cryptographic_hash_or_signature(commitment)
    return {signature: TSIG, anchor: ref(TA), behaviorCommitment: commit(BV),
context: commit(IC), attestation: ref(PA), nonce: N}
```

### Behavioral Proof, SceneKey, and Synthetic Behavior Detection

A Behavioral Proof verifier determines whether a claimed behavior is sufficiently supported by the captured signals, identity context, time anchor, device proof, and service context. In some embodiments, a SceneKey combines time, behavior, environment, identity, device, location, and service attributes to determine whether the event is contextually valid.

A non-limiting SceneKey may include a time window identifier, behavior category, location or service context, device attestation, identity reference, and policy rule. The verifier compares the SceneKey against the Behavior Vector and identity context. A proof may pass only if the signal confidence, temporal consistency, identity binding, and policy requirements exceed thresholds.

Synthetic behavior detection may identify AI-generated, simulated, replayed, or inconsistent behavior. In one embodiment, the system evaluates entropy metrics across time spacing, behavior density, device sequence, location continuity, interaction cadence, biometric consistency, and domain-context consistency. A low-entropy or inconsistent pattern may be rejected, flagged for audit, rate-limited, or prevented from causing conditioned issuance.

### Privacy Filtering and Zero-Knowledge Verification

The privacy module preserves authentication utility without exposing raw personal, biometric, behavioral, emotional, health, service, or communication content. A privacy filter may replace raw values with commitments, hashes, ranges, classifications, masked fields, or selective disclosure references. A zero-knowledge proof may verify that a predicate is true, such as that a behavior occurred within a time window, that a credential was valid, that a device attestation was present, or that a confidence threshold was met.

For example, a healthcare service event may generate a Time Signature proving that a care event occurred during a time window and was associated with a licensed service role, without disclosing medical content. A family care event may prove care time without exposing private family details. A learning event may prove attendance or engagement without disclosing educational content. An institutional contribution event may prove service occurrence without disclosing confidential institutional records.

The privacy and zero-knowledge module may produce a proof reference stored with the BEI-TSIG. The proof reference may be checked by a TimeNode, wallet, index endpoint, exchange endpoint, licensing endpoint, audit endpoint, or authorized institution.

### Entropy Anti-Spoofing and Replay Prevention

An entropy anti-spoofing module detects replay, duplicate issuance, AI-generated behavior, bot activity, inconsistent location, inconsistent device sequence, identity mismatch, time-window mismatch, or repeated behavior submissions. The module may use nonce binding, epoch windows, device attestation, behavior-density thresholds, signal diversity, confidence scoring, location continuity, identity consistency, and prior signature history.

In one embodiment, the system maintains a replay-prevention counter associated with a Time Wallet, identity reference, device, or signature series. A conditioned issuance request fails if a nonce has been used, if a time window has closed, if an attestation is stale, if a duplicate behavior vector is detected, or if entropy metrics indicate synthetic behavior.

The anti-spoofing output may be stored as metadata in the signature, Time Wallet, or TimeNode audit record. This improves security and integrity of distributed time-certification systems by preventing fraudulent generation or verification of time-certified assets.

### BEIMINT Conditioned Issuance State Machine

BEIMINT is implemented as a conditioned cryptographic issuance process or state machine. In one embodiment, an event begins in an Unverified state. After assignment of a Time-of-Time Anchor, the event enters a Time-Anchored state. After generation of a valid Behavior Vector and identity context, the event enters a Signature-Generated state. After Behavioral Proof verification, privacy or zero-knowledge verification, and entropy anti-spoofing, the event enters a Time-Certified state. Only then may a time-certified digital asset be generated, updated, transferred, accumulated, or certified.

The state machine may include states such as Unverified, Time-Anchored, Behavior-Vectorized, Signature-Generated, Proof-Verified, Privacy-Verified, Entropy-Approved, Time-Certified, Issued, Stored, Synchronized, Indexed, Exchanged, Licensed, Audited, Revoked, Masked, or Archived. Not all states are required in every embodiment.

The BEIMINT state machine avoids treating issuance as an abstract economic act. It is a technical state transition triggered by validation of a composite cryptographic signature and behavioral proof. TimeCoin, TimeCurrency, BEI Currency, BI Currency, or similar names are optional labels for the resulting time-certified digital asset or certified data unit.

### Timecertified Digital Assets, TimeCoin, TimeCurrency, BEI Currency, and BI Currency

A time-certified digital asset is a machine-readable record generated from a valid BEI Composite Time Signature. It may include asset identifier, signature reference, owner reference, wallet reference, time window, usage category, service category, behavior category, identity reference, issuance state, lifecycle state, privacy policy, audit reference, contribution score, index reference, and synchronization status.

In certain embodiments, the asset may be referred to as a TimeCoin, TimeCurrency unit, BEI Currency unit, BI Currency unit, time-certified data unit, time-value record, certified contribution unit, or other non-limiting name. These terms do not require any particular blockchain, token standard, securities classification, fiat conversion, exchange listing, financial product, or payment instrument. The asset may be used for certification, storage, audit, index, exchange validation, licensing, or identity-linked authorization according to the implementation.

Assets may correspond to discrete time events, fractional time intervals, continuous service events, device events, care events, learning events, health events, institutional events, communication events, or contribution events. Continuous or fractional events may update or accumulate asset units over time.

### Time Wallet, TimeVault, Lifecycle, and Inheritance

A Time Wallet or TimeVault stores Time Signatures, time-certified assets, identity references, lifecycle metadata, beneficiary permissions, inheritance rules, rights metadata, contribution scores, privacy policies, audit references, and synchronization records. A wallet may be associated with an individual, family, institution, community, organization, industry, region, nation, or international institution.

Lifecycle metadata may include creation time, verification status, usage category, service category, access policy, expiration policy, time-decay access control, multi-signature attestation requirement, beneficiary rule, family rule, institutional rule, legacy transfer rule, archive state, masking state, revocation state, or index status. A TimeVault may provide long-term storage, inheritance, or asset-package support.

Inheritance and beneficiary features are implemented as technical access-control and metadata-transition rules. They do not require a particular legal trust, financial product, or jurisdiction. A family care time asset, for example, may be transferred or referenced according to a beneficiary rule only if a TimeNode verifies the underlying BEI-TSIG and wallet policy.

### Time Sync API and Distributed TimeNodes

The Time Sync API enables issuance, query, verification, synchronization, audit, index, exchange validation, licensing validation, wallet access verification, and service-event verification. A TimeNode may be a server, edge node, wallet node, institutional node, regional node, national node, international node, device node, healthcare node, education node, family node, or private node.

In one embodiment, a third-party system submits a verification request to the Time Sync API. The request may include a signature identifier, asset identifier, wallet reference, identity reference, proof reference, node identifier, requested purpose, and privacy scope. The response may include a verification status, confidence level, time window, issuer node, proof validity, masking state, audit reference, and optional index output.

The Time Sync API creates a verification toll booth for downstream systems. A downstream wallet, DID platform, index endpoint, exchange endpoint, healthcare provider, employer, educational institution, family system, or government node may verify time authenticity through the claimed Time Sync logic without requiring access to raw personal data.

### Non-Limiting Request and Response Fields:

| API message | Representative fields | Purpose |
|---|---|---|
| VerifySignatureRequest | signatureId, assetId, | request validation |
| | walletId, verifierId, | of a BEI-TSIG |
| | purpose, privacyScope, | or time-certified |
| | proofReference | asset |
| VerifySignatureResponse | verificationStatus, | return privacy- |
| | confidence, | preserving |
| | timeWindow, | verification |
| | nodeProof, | state |
| | auditReference, | |
| | indexReference | |
| SyncRecord | signatureId, nodeId, | synchronize |
| | priorState, newState, | verified |
| | synchronizationTime, | state across |
| | auditHash | TimeNodes |

### Standards and Interoperability

The system may interoperate with decentralized identifiers, verifiable credentials, wallet protocols, REST interfaces, gRPC interfaces, JSON-LD schemas, OpenAPI specifications, hardware security modules, trusted execution environments, secure elements, edge nodes, local networks, public networks, private networks, and distributed ledgers. These examples are non-limiting.

A non-limiting JSON-like representation of a Time Signature may include fields such as signatureId, timeAnchor, behaviorCommitment, identityContext, domainContext, deviceAttestation, nonce, algorithm, proofReference, privacyScope, issuerNode, and synchronizationStatus. A Time Sync API request may include signatureId, assetId, walletId, verifierId, purpose, privacyScope, timestamp, and proofReference. A response may include verificationStatus, confidence, timeWindow, nodeProof, auditReference, and indexReference.

The described interfaces permit API licensing, SDK licensing, wallet integration, DID integration, index integration, exchange validation, TimeNode operation, institutional deployment, and asset-package integration while preserving the root BEI Time-of-Time architecture.

### Organic Cellular Domain and Identifier Fabric Since Around 1999

In certain embodiments, a historically prepared domain-name and identifier infrastructure beginning around 1999 may provide a deployment fabric for the BEI Time-of-Time system. Such fabric may be arranged as organic, green, cellular, hive-like, or multi-system. These terms describe modular, distributed, interoperable, extensible, energy-aware, service-aware, context-aware, and identifier-linked deployment architectures and do not require any biological structure, environmental certification, registrar, hosting provider, website, or commercial platform.

Non-limiting examples of domains or endpoints that may be associated with the deployment fabric include BEI.app, BEIECO.com, MF.app, ATMS.com, 24HWS.com, TimeStd.com, TimeStd.org, TimeStd.app, TimeStandard.app, TimeSignature.app, BEITOT.com, TimeOfTime.org, TheTimeOfTime.com, TimeAnchor.org, TimeCurrency.com, TimeCurrency.app, BEICurrency.com, BICurrency.com, BEIMINT.com, BEITimeCurrency.com, BEITimeCoin.com, TimeCoin.app, TimeCoins.org, TimeID.app, TimeID.org, TimeIdentity.app, TimeDID.com, DIDTime.org, IDTime.org, BEITimeID.com, TimeLedger.org, TimeLedgers.app, TimeVaultX.com, Times Vault.com, TimeMint.app, TimeMinting.com, TimeIndex.org, TimeIndex.us, TimeBehaviorIndex.com, TimeBehaviorHub.com, TimeAssets.app, TimeFRQ.com, TimeGR.com, SovereignTime.com, TimeSov.org, BEIGX.com, BEICX.com, BEISX.com, BIZX.com, BEIIndex.com, hours.us, days.us, week.us, years.us, yrs.us, 168bank.com, 120.us, medicalcenter.us, UQAK.com, and 36JI.com.

The domain examples are illustrative only and do not limit the claimed invention. The same functions may be implemented with or without domain names and may use decentralized identifiers, public keys, wallet addresses, blockchain addresses, smart contract addresses, device identifiers, secure elements, QR codes, NFC tags, HSM identifiers, TEE attestations, verifiable credential references, OIDC identifiers, edge-computing node identifiers, local endpoints, embedded identifiers, offline keys, or other identifiers.

### Value Aggregation Vault and Undeveloped Behavioral-Economic Namespace

A Value Aggregation Vault may operate as a treasure-bowl implementation by aggregating TimeCoins, Time Signatures, identity credentials, domain-linked assets, contribution records, index outputs, wallet records, exchange records, licensing records, and synchronization records associated with a user, family, institution, region, industry, or service domain. Such a vault may support asset packages, licensing packages, inheritance packages, contribution packages, or institutional reporting packages.

An Undeveloped Behavioral-Economic Namespace may operate as a virgin-land implementation. It may represent a domain, subdomain, industry sector, service category, geographic region, time interval, family class, identity class, or contribution category that has not yet been activated by verified Time Signatures or time-certified assets. Such namespace may be activated through generation of Time Signatures, BEIMINT conditioned issuance, TimeNode synchronization, or linking to a BID, DID, ReadName, or TimeID identity.

### Optional Index, Exchange, Licensing, and Asset-Package Layers

Optional index endpoints may generate TimeIndex, BEIIndex, BEIIDX, BIIDX, contribution score, behavior index, identity index, frequency index, service index, or domain-specific time-value outputs. Optional exchange endpoints may verify a BEI-TSIG or time-certified asset before transfer, authorization, listing, licensing, settlement, or access. These endpoints are downstream of the root system and are not required for practicing the claimed root time-certification and conditioned issuance system.

Optional licensing embodiments may include API licensing, SDK licensing, TimeNode operation licensing, wallet integration licensing, index co-branding, exchange validation licensing, institutional deployment licensing, and asset-package sublicensing. These commercial embodiments are illustrative and do not limit the technical scope of the claims.

### Portfolio Boundary and Cross-Protection

The present disclosure provides a root time-certification and conditioned issuance layer. Other systems may provide downstream financial clearing, valuation metering, domain routing, payment settlement, exchange listing, index generation, regulatory reporting, or licensing. For example, a financial clearing layer may process time-certified assets after issuance, a valuation layer may compute value metrics, a domain routing layer may route identifiers, and a payment settlement layer may settle transfers. Such downstream layers may interoperate with the root BEI Time-of-Time layer but are not required for practicing the root system.

This boundary supports cross-portfolio protection. The root layer protects Time-of-Time anchoring, BEI composite time signatures, behavioral proof, BEIMINT conditioned issuance, secure storage, and TimeNode synchronization. Downstream layers may separately protect clearing, valuation, domain-ring routing, payment-ring settlement, media settlement, or other specialized functions.

### Technical Advantages Over Prior Systems

Prior systems may authenticate identity, record time, issue tokens, or store credentials separately. A timestamp system can show when data existed but does not establish a fused time-behavior-identity proof. A DID system may identify a subject but does not necessarily bind a behavior vector and Time-of-Time anchor into a composite signature. A biometric identity system can authenticate a body or device but does not necessarily condition issuance of a time-certified asset on a BEI-TSIG and TimeNode synchronization. A time-banking system can record hours but does not necessarily generate privacy-preserving cryptographic signatures or distributed verification records.

The present system improves security, integrity, and privacy of distributed time-certification systems by fusing a Time-of-Time Anchor, Behavior Vector, identity/domain/identifier context, proof attestation, and nonce into a BEI Composite Time Signature. It then verifies the signature using behavioral proof, privacy or zero-knowledge verification, entropy anti-spoofing, and TimeNode synchronization before conditioned issuance or verification. This integrated pipeline provides a technical mechanism that is distinct from ordinary timestamping, ordinary identity verification, ordinary token issuance, ordinary time banking, and ordinary wallet storage.

### Example Implementations

In a healthcare care-time implementation, a caregiver event is captured by a device, institutional proof, service record, or communication session. The signal fusion engine generates a Behavior Vector, the Time-of-Time Anchor module assigns a time reference, the BEI-TSIG generator produces a signature, and BEIMINT conditionally issues a time-certified care asset. A TimeNode can verify the asset without exposing medical content.

In an education implementation, a learning event is certified by attendance, interaction, credential, device, and time-window signals. The resulting Time Signature may be stored in a Time Wallet and used by an institution or index endpoint to verify learning time while protecting student privacy.

In a family inheritance implementation, a TimeVault stores family care time, identity records, lifecycle metadata, beneficiary permissions, and legacy transfer rules. Transfer or reference of a time-certified asset is permitted only after TimeNode verification of the underlying BEI-TSIG and wallet policy.

In an industry or employment implementation, labor or service events are converted into time-certified records that may be verified through a Time Sync API. The system can support human work verification, AI-generated behavior detection, service time certification, and contribution scoring without requiring raw surveillance data.

In a national, regional, or international institutional implementation, TimeNodes operated by authorized institutions synchronize verified signatures, audit records, and index outputs. The system can provide a standardized technical interface for human-time certification without requiring a single central authority.

### BRIEF DESCRIPTION OF THE DRAWINGS

FIG. 1 illustrates BEI Time-of-Time overall architecture showing root layers from Time-of-Time Anchor to BEI-TSIG, BEIMINT, storage, synchronization, and optional downstream endpoints.

FIG. 2 illustrates Time-of-Time Anchor and life-origin time showing non-limiting temporal sources and time-unit anchors.

FIG. 3 illustrates Identity binding using BID, DID, ReadName, TimeID, domain and non-domain identifiers.

FIG. 4 illustrates BEI signal fusion engine receiving raw signals, normalizing them, and generating a Behavior Vector.

FIG. 5 illustrates BEI Composite Time Signature generation from Time-of-Time Anchor, Behavior Vector, identity/domain/identifier context, proof attestation, and nonce.

FIG. 6 illustrates SceneKey and behavioral proof verification using time, behavior, environment, device, identity, and service context.

FIG. 7 illustrates Privacy filtering, zero-knowledge verification, entropy anti-spoofing, replay prevention, and synthetic behavior detection.

FIG. 8 illustrates BEIMINT conditioned issuance state machine from Unverified to Time-Certified, Issued, Stored, and Synchronized.

FIG. 9 illustrates Time Wallet and TimeVault lifecycle, inheritance, beneficiary, rights, and contribution score metadata.

FIG. 10 illustrates Time Sync API and distributed TimeNodes supporting verification request-response, audit, index, and wallet access.

FIG. 11 illustrates Optional index, exchange, licensing, and asset-package endpoints downstream of the root layer.

FIG. 12 illustrates Domain and non-domain identifier deployment fabric including domains, DIDs, public keys, wallets, HSMs, TEEs, QR, NFC, and edge nodes.

### DETAILED DESCRIPTION OF THE DRAWINGS

Each drawing is schematic and non-limiting. The illustrated components may be combined, divided, reordered, implemented in hardware, implemented in software, implemented in firmware, implemented in cloud infrastructure, implemented at an edge node, implemented in a wallet, implemented in an embedded device, or implemented using combinations thereof.

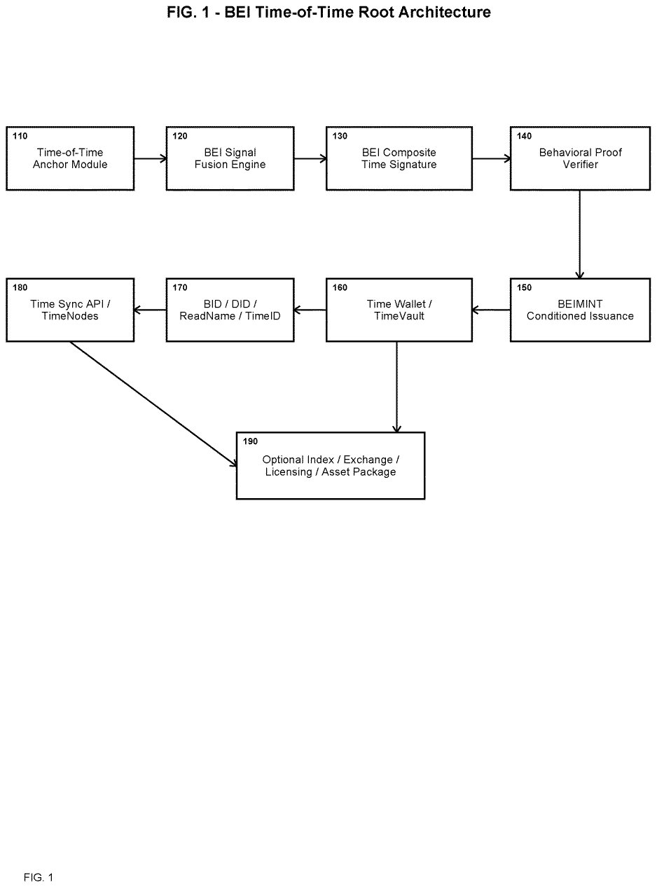

FIG. 1 depicts BEI Time-of-Time overall architecture showing root layers from Time-of-Time Anchor to BEI-TSIG, BEIMINT, storage, synchronization, and optional downstream endpoints. The reference numerals in the drawing identify representative modules and data flows, but the same functions may be implemented using different physical or logical arrangements.

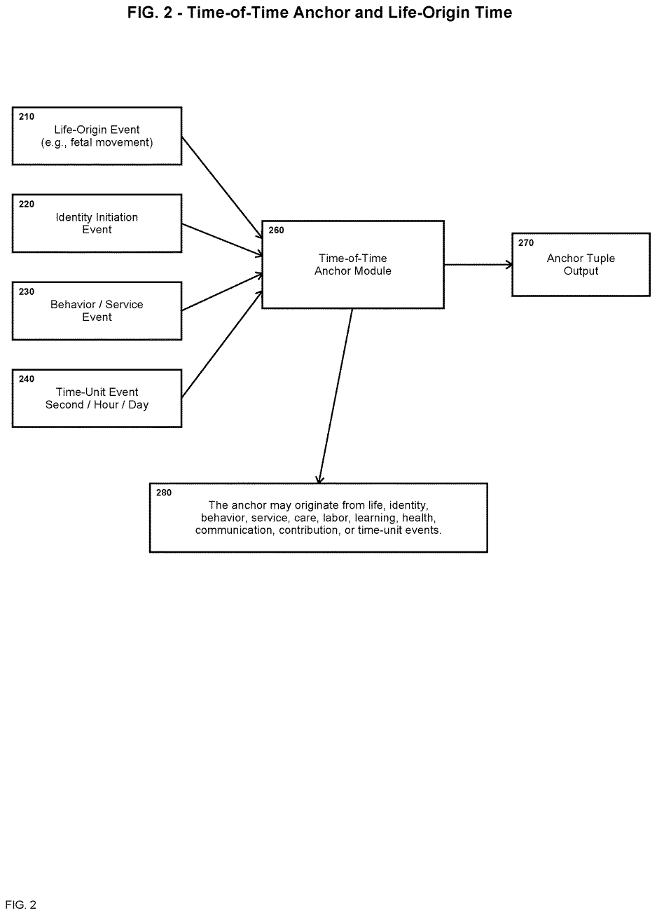

FIG. 2 depicts Time-of-Time Anchor and life-origin time showing non-limiting temporal sources and time-unit anchors. The reference numerals in the drawing identify representative modules and data flows, but the same functions may be implemented using different physical or logical arrangements.

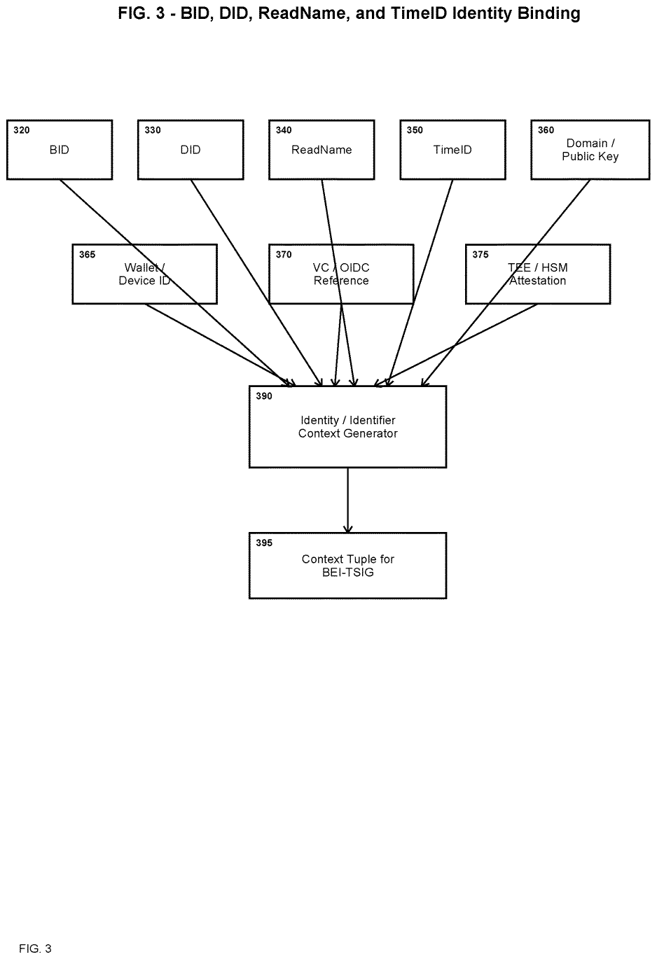

FIG. 3 depicts Identity binding using BID, DID, ReadName, TimeID, domain and non-domain identifiers. The reference numerals in the drawing identify representative modules and data flows, but the same functions may be implemented using different physical or logical arrangements.

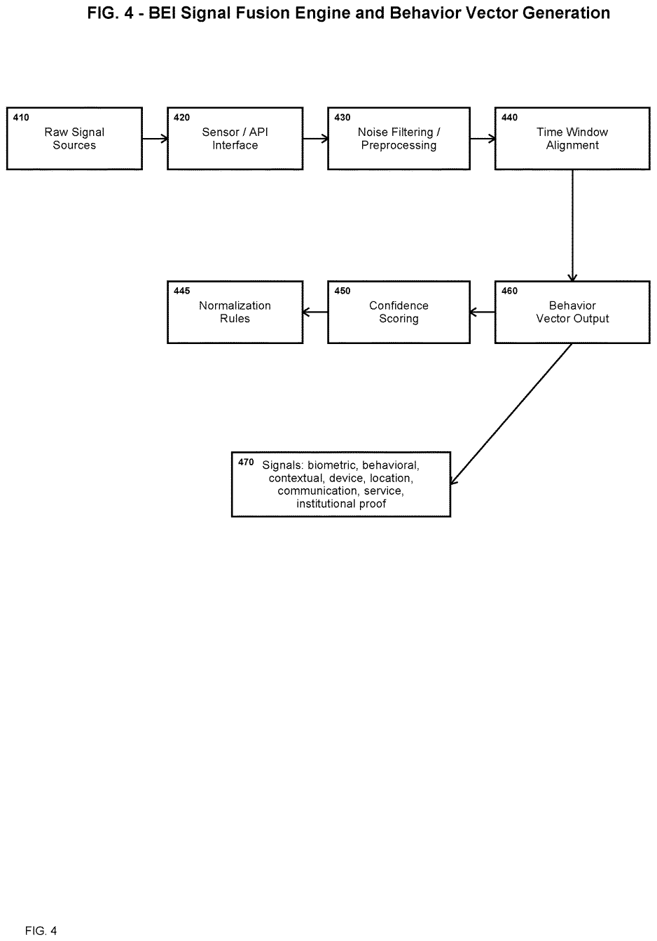

FIG. 4 depicts BEI signal fusion engine receiving raw signals, normalizing them, and generating a Behavior Vector. The reference numerals in the drawing identify representative modules and data flows, but the same functions may be implemented using different physical or logical arrangements.

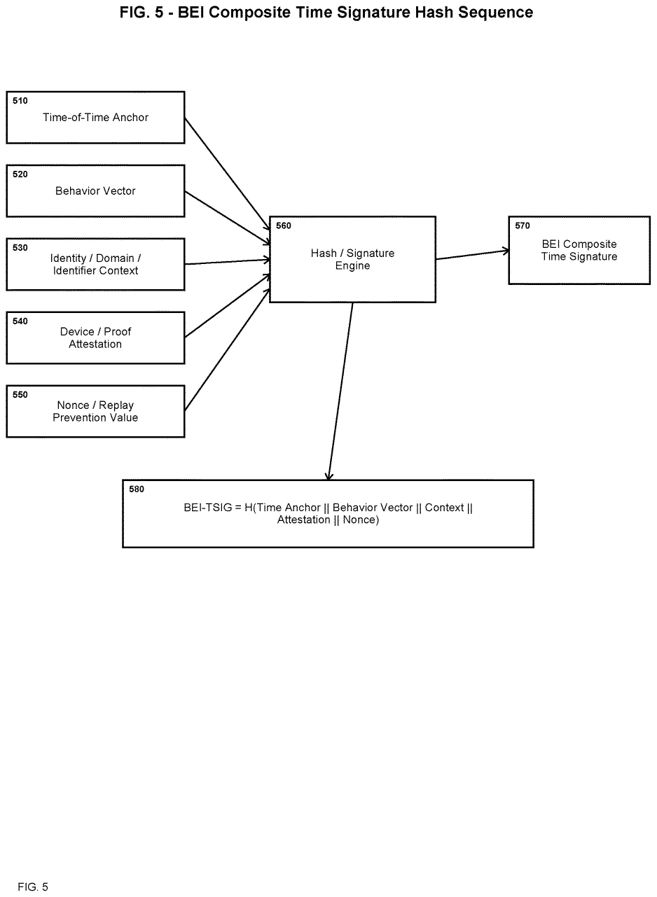

FIG. 5 depicts BEI Composite Time Signature generation from Time-of-Time Anchor, Behavior Vector, identity/domain/identifier context, proof attestation, and nonce. The reference numerals in the drawing identify representative modules and data flows, but the same functions may be implemented using different physical or logical arrangements.

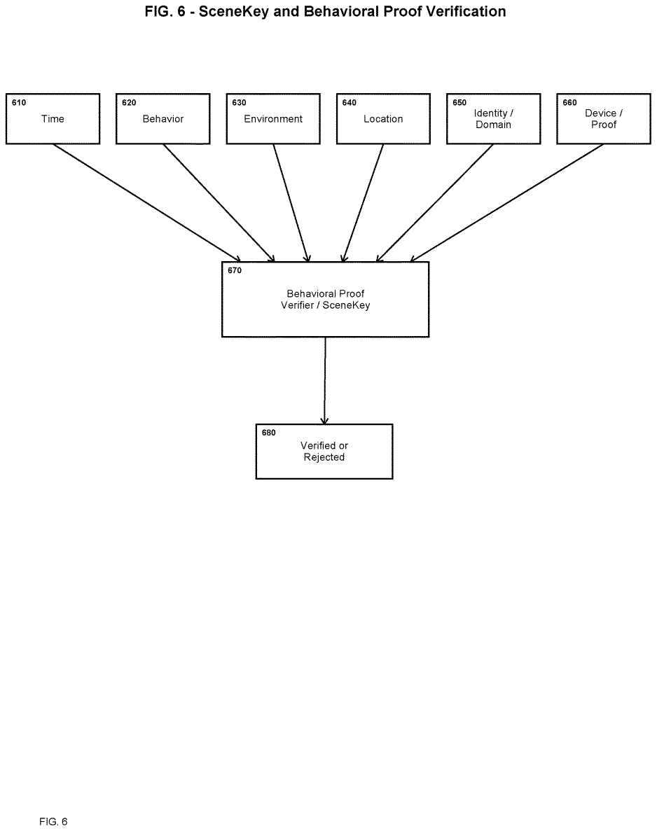

FIG. 6 depicts SceneKey and behavioral proof verification using time, behavior, environment, device, identity, and service context. The reference numerals in the drawing identify representative modules and data flows, but the same functions may be implemented using different physical or logical arrangements.

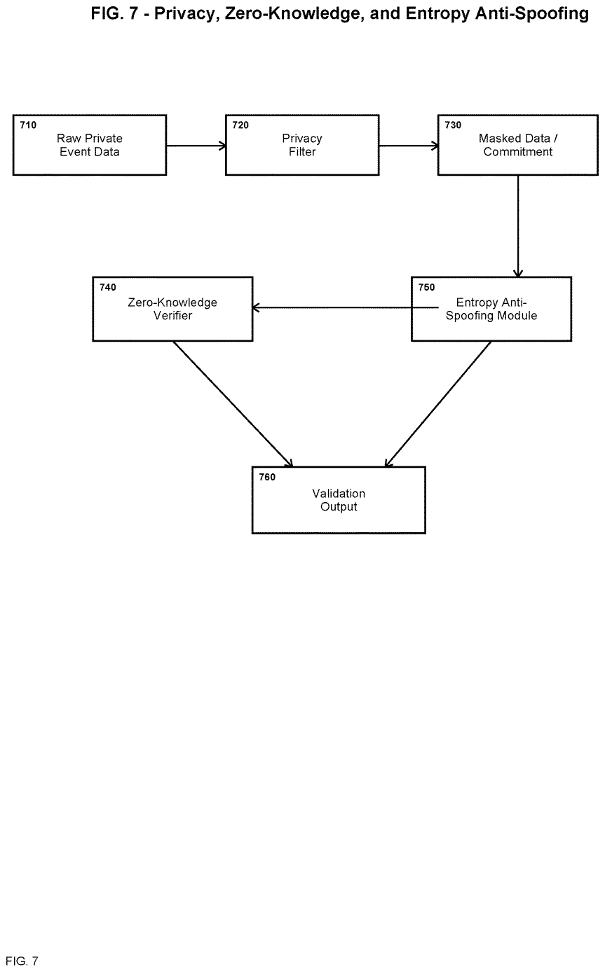

FIG. 7 depicts Privacy filtering, zero-knowledge verification, entropy anti-spoofing, replay prevention, and synthetic behavior detection. The reference numerals in the drawing identify representative modules and data flows, but the same functions may be implemented using different physical or logical arrangements.

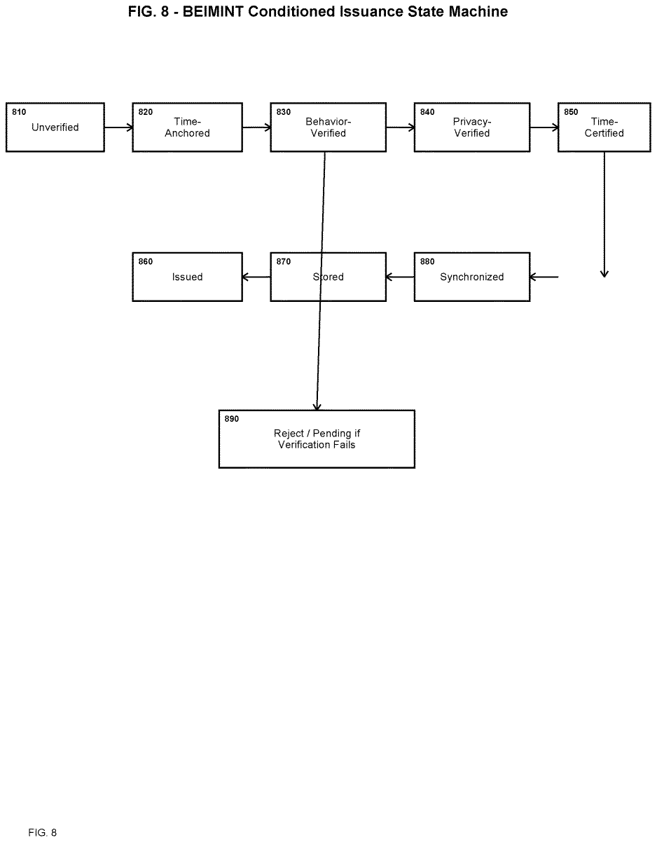

FIG. 8 depicts BEIMINT conditioned issuance state machine from Unverified to Time-Certified, Issued, Stored, and Synchronized. The reference numerals in the drawing identify representative modules and data flows, but the same functions may be implemented using different physical or logical arrangements.

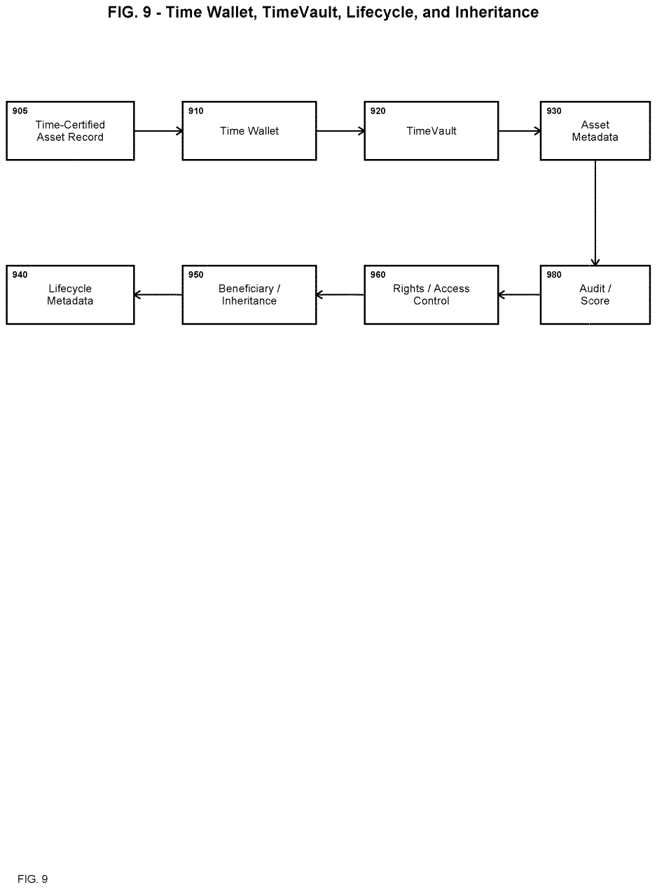

FIG. 9 depicts Time Wallet and TimeVault lifecycle, inheritance, beneficiary, rights, and contribution score metadata. The reference numerals in the drawing identify representative modules and data flows, but the same functions may be implemented using different physical or logical arrangements.

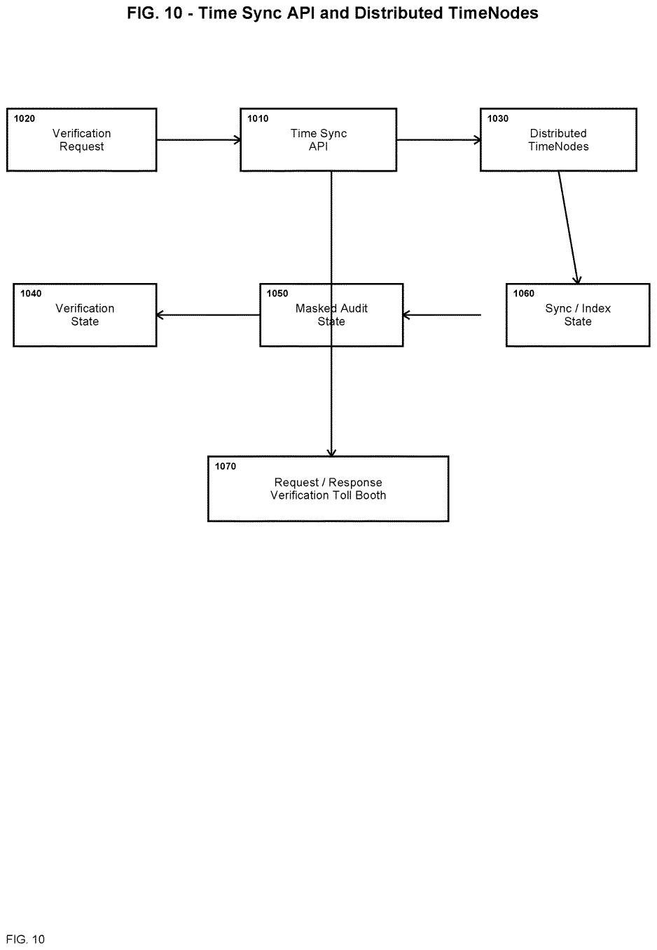

FIG. 10 depicts Time Sync API and distributed TimeNodes supporting verification request-response, audit, index, and wallet access. The reference numerals in the drawing identify representative modules and data flows, but the same functions may be implemented using different physical or logical arrangements.

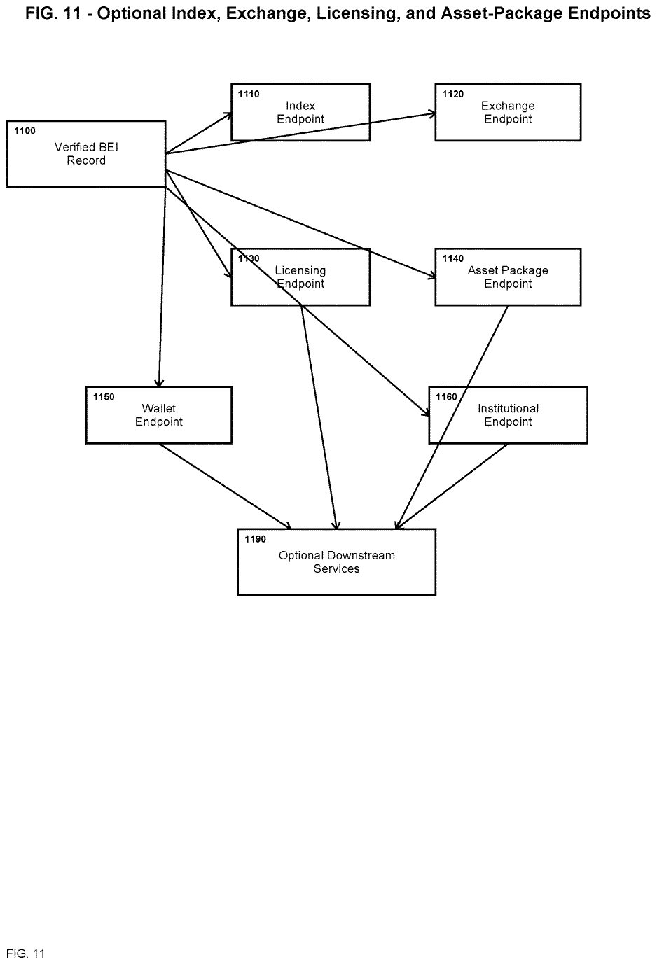

FIG. 11 depicts Optional index, exchange, licensing, and asset-package endpoints downstream of the root layer. The reference numerals in the drawing identify representative modules and data flows, but the same functions may be implemented using different physical or logical arrangements.

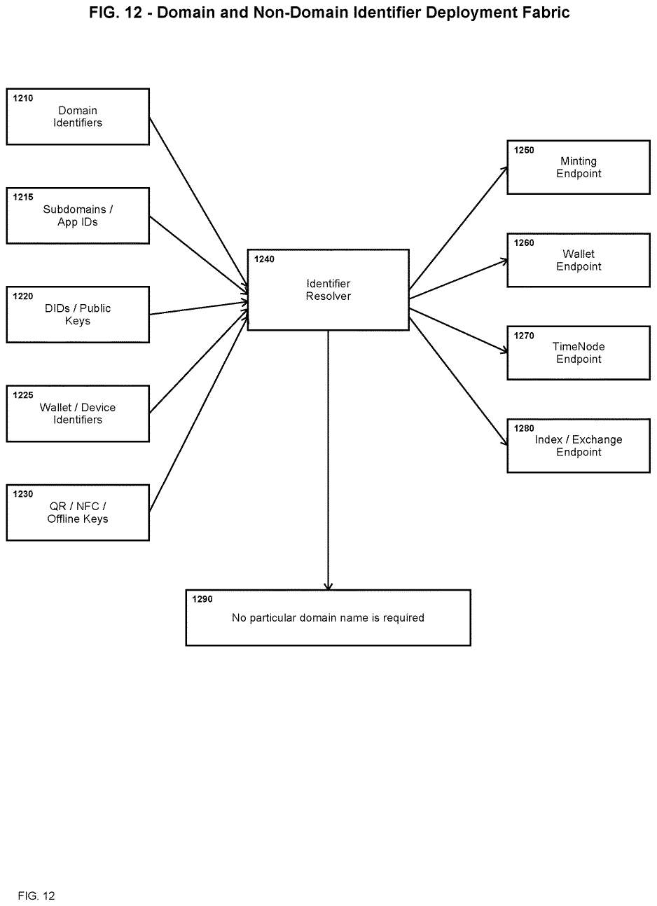

FIG. 12 depicts Domain and non-domain identifier deployment fabric including domains, DIDs, public keys, wallets, HSMs, TEEs, QR, NFC, and edge nodes. The reference numerals in the drawing identify representative modules and data flows, but the same functions may be implemented using different physical or logical arrangements.

### NON-LIMITING VARIATIONS

The disclosed system may operate on a public network, private network, hybrid network, local network, offline network, edge-computing network, distributed ledger, centralized database, federated database, wallet infrastructure, institutional system, or embedded device environment. No particular blockchain, domain name, registry, wallet, exchange, token standard, jurisdiction, monetary system, cloud provider, or identity provider is required unless expressly recited in a claim.

The order of operations may be varied where technically suitable. For example, identity context may be generated before or after signal normalization; privacy filtering may occur before or after behavior vector generation; TimeNode synchronization may occur before or after indexing; and issuance may be delayed until additional proofs are available. Optional downstream exchange, index, licensing, or asset-package functions may be omitted without departing from the root BEI Time-of-Time system.

### Supplemental Detailed Embodiments

The following supplemental embodiments provide additional technical detail for implementing the BEI Time-of-Time root infrastructure. They are illustrative and non-limiting, and are provided to support enablement, interoperability, and practical deployment across individuals, families, industries, institutions, regions, nations, and international bodies.

### Detailed Embodiments of the Time-of-Time Anchor

The Time-of-Time Anchor may be implemented as a deterministic anchor object. In one embodiment, an anchor object includes an anchor identifier, source type, source attestation, time window, local clock value, optional network time value, optional ledger time value, confidence score, privacy class, and policy reference. The anchor object may be derived from a life-origin event, identity-initiation event, service event, device event, care event, learning event, labor event, or contribution event. The anchor object may be used directly in BEI-TSIG generation or may be committed through a hash, Merkle leaf, or verifiable credential reference.

A Time-of-Time Anchor may be absolute, relative, or hybrid. An absolute anchor may reference a UTC or local time source. A relative anchor may reference elapsed time from a life-origin event, enrollment event, device enrollment, institutional credential issuance, or first verified behavior. A hybrid anchor may include both absolute time and a relative sequence. This permits the system to function in conventional internet environments, delayed networks, edge networks, intermittent networks, local care environments, disaster environments, remote healthcare environments, and other settings in which a central clock is unavailable or unreliable.

In one embodiment, an anchor module receives multiple time sources and performs source ranking. A hardware clock, secure enclave clock, network time response, distributed ledger timestamp, institutional timestamp, mobile device timestamp, and edge node timestamp may each provide a candidate time. The module may select one or more sources based on policy, confidence, latency, attestation strength, and consistency. If time sources conflict, the module may generate a tolerance window rather than a single instant. The resulting anchor remains suitable for cryptographic signature generation and behavioral proof verification.

A Time-of-Time Anchor may preserve historical continuity. For example, a family may associate a child's life-origin time with a later education record, healthcare record, care record, or contribution record. An institution may associate a first enrollment timestamp with later verified service events. A region may associate a time-unit endpoint with local service records. In each case, the anchor does not itself create economic value; it provides a technical temporal reference that allows later behavior and identity records to be certified.

Non-limiting temporal-unit implementations may include seconds, minutes, hours, days, weeks, months, years, fractional intervals, event-defined intervals, service windows, care windows, learning windows, treatment windows, work windows, communication windows, and contribution periods. Domains such as hours.us, days.us, week.us, years.us, and yrs.us may be used as illustrative endpoints for time-unit services, but the system does not require these or any other domains.

### Detailed Embodiments of BEI Identity, BID, DID, ReadName, and TimeID

BEI identity is broader than a conventional decentralized identifier. A DID may identify a subject, while a BEI identity binds a subject to verified time events, behavior vectors, contribution records, service contexts, wallet records, and synchronization records. The system may therefore use a DID as a carrier while adding BEI-specific time and behavior certification. In other embodiments, a BID may be used for behavior-linked identity, a ReadName may be used for human-readable identity or domain-linked identity, and a TimeID may be used for time-indexed identity.

An identity binding module may associate one or more identifiers with a Time Wallet. A person may have a BID, DID, ReadName, TimeID, wallet address, public key, domain identifier, device identifier, and institutional credential. A family may have a family ReadName or family wallet. An institution may have an institutional node or institutional credential. A device may have a secure element identifier, TEE attestation report, HSM-bound key, or device public key. The system may bind any of these identifiers to a time event according to policy.

The identity layer may be privacy-preserving. A subject may prove possession of a credential without revealing the credential contents. A wallet may prove that it is linked to a valid identity context without revealing the subject's full personal information. A TimeNode may verify that a credential issuer is trusted without seeing raw identity content. These privacy-preserving identity bindings support healthcare, education, family, employment, and institutional deployments.

In certain embodiments, BEI identity includes role metadata. Role metadata may indicate care role, medical role, education role, service role, labor role, family role, institutional role, regional role, professional role, or contribution role. The role metadata may be included directly, hashed, or referenced through a verifiable credential. A role may affect the behavioral proof policy, but the claims do not require any particular role classification.

Identity context may also include consent state, privacy scope, access rights, delegation, revocation state, beneficiary status, and institutional authority. These metadata fields support lifecycle management without making the patent a legal trust system. The technical function is to determine whether a time event, behavior vector, or asset state may be verified, stored, synchronized, disclosed, transferred, indexed, or licensed.

### Detailed Signal Normalization and Behavior Vector Generation

Raw signals may have different formats, sampling frequencies, noise characteristics, privacy sensitivity, and proof strength. The signal fusion engine therefore may normalize heterogeneous signals into a unified Behavior Vector. For example, an accelerometer signal may be sampled at one frequency, a communication event may arrive as an API record, a location signal may arrive as a GPS coordinate, and an institutional proof may arrive as a signed credential. The engine maps these inputs into a common time window and data structure.

In one embodiment, signal normalization includes source validation, time-window assignment, noise filtering, unit conversion, feature extraction, hashing, confidence scoring, and policy classification. Source validation verifies that the signal originated from an acceptable source. Time-window assignment maps the signal to a Time-of-Time Anchor or a tolerance window. Noise filtering removes outliers or low-confidence samples. Feature extraction converts raw values into behavior features. Hashing or commitment protects privacy. Confidence scoring estimates reliability. Policy classification identifies the proof policy applicable to the event.

Behavior Vector features may include behavior category, signal type, feature hash, time window, confidence score, source attestation, location context, device proof, role metadata, service category, privacy level, and policy reference. The vector may omit raw sensitive data. A vector for a care event may include care category, time window, caregiver role proof, device proof, and institutional proof reference. A vector for a learning event may include attendance proof, engagement window, identity reference, and institutional credential reference.

A Behavior Vector may be constructed from a single signal or multiple signals. A low-risk event may require a signed service record. A high-value event may require multiple independent signals, such as a device attestation, identity credential, location consistency, and behavioral sequence. The system may select a proof strength based on policy, value category, privacy scope, regulatory requirement, or downstream verification requirement.

The fusion process may be deterministic so that authorized verifiers can reproduce or verify commitments without raw data. Determinism supports auditability and § 112 enablement. For example, the system may specify a feature extraction routine, time-window rule, confidence formula, and hash commitment scheme. Different embodiments may use different algorithms, but each embodiment should produce a Behavior Vector suitable for BEI-TSIG generation.

### BEI-TSIG Data Structures, Schemas, and Pseudocode

A BEI Composite Time Signature may be represented as a tuple, JSON-LD object, binary object, verifiable credential extension, certificate extension, wallet record, database record, or ledger record. A non-limiting tuple includes signatureId, algorithm, timeAnchorRef, behavior VectorCommitment, identityContextCommitment, proofAttestationRef, nonce, issuerNode, privacyScope, proofPolicy, verificationStatus, and synchronizationStatus.

In a JSON-LD implementation, a @context may define terms such as timeAnchor, behaviorProof, sceneKey, identityContext, domainContext, identifierContext, proofAttestation, entropy Score, privacyScope, zeroKnowledgeProofRef, issuanceState, walletRef, and syncStatus. A wallet or DID system may store the object as a verifiable credential or may reference it from a credential. These data structures are non-limiting and do not require W3C or any other standard, but they support interoperability.

In a hash-chain implementation, each BEI-TSIG may reference a prior signature or wallet state. The resulting chain can show continuity of a subject's time-certified records while preserving privacy. In a Merkle implementation, a group of signatures may be committed into a Merkle root synchronized by TimeNodes. In a local device implementation, the signature may be generated offline and later synchronized when connectivity returns.

Non-limiting pseudocode includes: derive Time-of-Time Anchor; normalize raw signals; construct Behavior Vector; construct Identity Context; collect device or proof attestation; generate nonce; compute BEI-TSIG; run behavioral proof; run privacy or zero-knowledge verification; run entropy anti-spoofing; update state machine; store record; synchronize with TimeNodes. This sequence may be reordered where technically appropriate, but conditioned issuance occurs only after verification succeeds.

The formula H(Time-of-Time Anchor∥Behavior Vector∥Identity/Domain/Identifier Context∥Device/Proof Attestation∥Nonce) is illustrative. Other cryptographic mechanisms may include digital signatures, keyed hashes, zero-knowledge commitments, secure enclave signatures, threshold signatures, multi-party computation outputs, post-quantum signatures, or hybrid schemes. The essential feature is the composite binding of time, behavior, and identity-context components into a verifiable signature that gates issuance or verification.

### Behavioral Proof Policies and SceneKey Implementations

A Behavioral Proof policy may define the minimum signals and verification thresholds required for a category of time event. A care event may require caregiver role proof and time-window proof. A medical event may require institutional credential proof. A learning event may require attendance and engagement signals. A labor event may require service proof and device attestation. A family event may require family identity context. A public service event may require institutional or regional node verification.

A SceneKey may be represented as a structured policy object. It may include scene type, event type, required signal classes, location rule, time window rule, identity rule, device rule, privacy rule, entropy threshold, and required proof type. The verifier evaluates the SceneKey against the Behavior Vector and identity context. A mismatch can cause rejection, masking, re-routing, manual audit, or lower confidence.

In a healthcare example, the SceneKey may require an institutional credential, care role, time window, and privacy mask. In an education example, it may require classroom or online session context, student identity, instructor credential, and engagement signal. In a device event example, it may require secure element attestation, device timestamp, and local sensor signal. The same root BEI-TSIG structure can support all examples without being limited to any industry.

SceneKey verification also supports synthetic behavior detection. For example, a behavior sequence generated by a bot may have unnatural timing, repeated patterns, inconsistent device telemetry, or missing context. A replayed signal may reuse a nonce or conflict with a prior time window. A fake service event may lack institutional proof. The entropy module can compute a risk score and block conditioned issuance.

Behavioral Proof can be implemented without disclosing raw data. The system may use commitments, ranges, predicates, or zero-knowledge proofs. A verifier may learn that a care event occurred and met a threshold without learning medical details. This supports privacy-preserving deployment across families, industries, institutions, and jurisdictions.

### BEIMINT State Transition Records and Technical State Changes

Conditioned issuance may be understood as a technical state transition rather than an economic transaction. The system changes a record from unverified to time-certified only when cryptographic and behavioral conditions are satisfied. The issuance module can be implemented as a state machine, database transaction, smart contract function, secure enclave routine, wallet instruction, server process, edge node process, or local application process.

An issuance state record may include prior state, requested state, signature reference, proof status, privacy status, entropy status, issuer node, time window, asset identifier, wallet reference, synchronization status, audit hash, and policy reference. If any required verification fails, the state transition may be denied, delayed, masked, or sent for audit. This prevents issuance from becoming a mere business rule.

BEIMINT may generate an asset, update an asset, transfer an asset, accumulate fractional units, attach metadata, renew a proof, certify a record, or mark an existing record as verified. For example, a continuous care event may accumulate certified time in fractional intervals. A device service event may update a usage record. A learning event may generate a certificate-like time record. A family asset may update a lifecycle state.

The state machine may optionally support revocation, masking, or archive states. A privacy change may mask portions of a record while preserving verification references. A revocation may prevent downstream use without deleting historical proof. An archive state may preserve record integrity for long-term inheritance or institutional audit. Such functions are optional and may be implemented differently by downstream systems.

By implementing BEIMINT as a technical state transition recorder, the system improves distributed data integrity. A downstream index or exchange cannot treat a time-certified asset as verified unless it can check the state transition record and the underlying BEI-TSIG or verification status.

### Time Sync API Request-Response and Verification Toll Booth

The Time Sync API may be a REST interface, gRPC interface, JSON-RPC interface, local procedure call, wallet protocol, DID resolver extension, verifiable credential verification endpoint, edge-node protocol, or embedded device interface. A non-limiting VerifySignatureRequest includes signatureId, assetId, walletId, identityRef, verifierId, purpose, privacyScope, proofReference, requestedFields, and verifierAttestation.

A non-limiting VerifySignatureResponse includes verificationStatus, confidence, timeWindow, issuerNode, proofValidity, entropyStatus, maskingState, auditReference, indexReference, permittedDisclosures, and expiration. The response may disclose only what the verifier is authorized to see. A healthcare provider, employer, school, family node, exchange endpoint, index service, or licensing endpoint may receive different disclosure levels.

The Time Sync API is a key licensing interface. A third-party system need not issue assets to practice verification. If it verifies a human time record, it may submit a verification request through an interface that checks the BEI-TSIG, proof status, wallet state, and TimeNode synchronization. This makes verification itself a protectable function, not merely issuance.

TimeNodes may synchronize by publishing commitments rather than raw records. A node may store a signature commitment, audit hash, synchronization timestamp, node signature, and privacy policy. Multiple nodes may compare commitments to detect tampering. A node may be operated by a family, institution, region, industry, healthcare system, education system, national agency, international body, or private service.

A Time Sync protocol may support online, offline, delayed, and intermittent synchronization. A local device may generate a BEI-TSIG offline and later synchronize through a TimeNode. A remote care environment may batch records. A cross-border institution may verify only masked proofs. This permits broad practical use without requiring any single central database.

### Lifecycle, Inheritance, and Long-Term Time Asset Management

Time Wallet and TimeVault implementations may support long-term management of time-certified assets. Lifecycle states may include created, active, restricted, inherited, delegated, masked, archived, verified, expired, revoked, indexed, licensed, transferred, or audited. Each state may be associated with rules controlling access, disclosure, synchronization, verification, and downstream use.

Inheritance and beneficiary rules may be technical access-control rules. A family wallet may specify that certain care-time records become visible to beneficiaries after a condition, such as a time threshold, multi-signature attestation, institutional confirmation, or death-related credential. A professional wallet may specify institutional successor access. A regional node may preserve public-service time records according to policy.

Time-decay access control may modify access or verification status over time. For example, raw proof details may become masked after a period, while the verification hash remains available. A contribution score may decay or be recalculated. An inherited record may remain verifiable but not transferable. These features are technical metadata transitions and do not require any particular legal characterization.

A TimeVault may support asset packages. A user, family, institution, industry, region, or nation may aggregate Time Signatures, time-certified assets, identity credentials, index outputs, exchange validation records, and licensing records. This supports valuation, transfer, licensing, audit, and intergenerational continuity while preserving privacy.

The system can therefore support human time as a durable technical asset record. It does not merely record hours; it preserves certified human time events in a privacy-preserving, identity-linked, synchronized, and lifecycle-managed structure.

### Industry, Family, National, Regional, and International Use Cases

For individuals, the system can certify learning, care, health, service, labor, communication, creativity, or contribution time. A person may store time-certified records in a Time Wallet and selectively share verification through the Time Sync API. The system supports personal dignity of time without forcing public exposure of private data.

For families, the system can certify care time, support inheritance rules, preserve family contribution records, and create a Value Aggregation Vault. Family members may hold different access permissions. A family TimeNode may coordinate with institutional nodes while preserving privacy.

For industries, the system can certify training time, professional service time, safety checks, device operations, human-in-the-loop AI supervision, maintenance events, and contribution records. Industry bodies may adopt TimeNodes or index endpoints to standardize verified time records across participants.

For national or regional systems, the system can support time-based public service records, healthcare workforce records, education contribution records, emergency service records, volunteer service records, and regional TimeIndex outputs. Such systems may verify human time without centralizing raw personal data.

For international institutions, the system can provide a common verification layer for cross-border care, education, humanitarian service, public health response, workforce certification, and development programs. A Time-of-Time standard can serve as a neutral interface by which institutions verify time events while respecting privacy, sovereignty, and local identifiers.

### Asset Package and Licensing Embodiments

In asset-package embodiments, the BEI Time-of-Time root patent may serve as the root layer of a broader portfolio. Downstream assets may include BEIMINT endpoints, Time Wallet implementations, TimeIndex services, BEIIndex services, exchange validation endpoints, domain identity layers, valuation models, payment settlement rings, and institutional nodes. The root layer provides the signature and verification standard that downstream systems may use.

Licensing embodiments may include API licensing for Time Sync verification, SDK licensing for wallet integration, node licensing for TimeNode operation, institutional licensing for healthcare or education, regional licensing for public service records, exchange licensing for asset verification before listing or transfer, index licensing for TimeIndex outputs, and asset-package sublicensing for ecosystem deployments.

Because the root layer is identifier-flexible, a licensee can integrate with existing DID wallets, enterprise databases, blockchain wallets, traditional authentication systems, mobile devices, wearables, edge nodes, or domain-based systems. This increases commercial utility while maintaining the distinctive BEI Time-of-Time standard.

For transaction, transfer, or authorization value, a purchaser or licensee may evaluate the patent as a root choke-point layer. The patent is not limited to a single application; it defines the required technical verification path for converting verified human time events into synchronized time-certified records. This supports valuation across multiple verticals without overclaiming any one vertical.

The disclosure therefore supports a long-term civilization-scale infrastructure while remaining grounded in implementable computer, identity, cryptographic, wallet, and synchronization modules. The claims protect the root pipeline; the specification describes the broader BEI ecosystem as non-limiting embodiments.

### Additional Non-Limiting Technical Variations

The system may use different cryptographic algorithms, including SHA-family hashes, keyed hashes, elliptic curve signatures, threshold signatures, post-quantum signatures, secure enclave signatures, or zero-knowledge-friendly commitments. The invention is not limited to one algorithm if the composite binding of time, behavior, and identity-context components is preserved.

The system may operate with raw signals, normalized signals, derived features, commitments, proofs, or references. In privacy-sensitive deployments, only commitments or proof references may leave a device. In high-assurance deployments, a TimeNode may require multiple independent attestations. In low-risk deployments, a single institutional proof may be sufficient.

The system may support multiple synchronization models. A centralized deployment may synchronize to one institutional node. A decentralized deployment may synchronize across many TimeNodes. A federated deployment may synchronize across regional or industry nodes. An offline deployment may store locally and later synchronize. The claims are not limited to a single network topology.

The system may support multiple asset forms. A time-certified asset may be represented as a database record, credential, token, certificate, receipt, ledger entry, wallet object, index input, exchange verification record, or encrypted archive. The use of TimeCoin or TimeCurrency terminology is illustrative and does not require any particular financial treatment.

The system may support multiple governance and policy models without making governance a claim limitation. Policies may be set by users, families, institutions, industries, regions, national bodies, international organizations, or software administrators. The technical system enforces verification, storage, synchronization, and disclosure rules according to machine-readable policy.

### Additional Implementation Detail and Standard Protocol Embodiments

The following additional embodiments further describe implementation details, protocol interfaces, data models, role models, non-limiting use cases, and cross-portfolio boundaries for the BEI Time-of-Time root infrastructure. They are included to support practical implementation, clarity, and interoperability while maintaining the root focus of the claims.

### BEI Time Standard Protocol Stack

The BEI Time Standard may be expressed as a layered protocol stack. A physical and institutional signal layer receives raw human, device, service, healthcare, education, labor, communication, family, regional, or institutional signals. A normalization layer converts those signals into commitments and a Behavior Vector. A time anchor layer assigns a Time-of-Time Anchor. An identity context layer binds BID, DID, ReadName, TimeID, or other identifiers. A composite signature layer generates BEI-TSIG. A proof layer verifies SceneKey, privacy, zero-knowledge, and entropy conditions. A conditioned issuance layer records a state transition. A storage layer stores the time-certified asset. A synchronization layer verifies the record across TimeNodes. Optional downstream layers may index, exchange, license, value, or package the record.

This layered protocol stack allows the invention to operate across heterogeneous systems. A healthcare provider may implement a healthcare signal layer and institutional TimeNode. A family may implement a family wallet and TimeVault. A school may implement education credentials. A region may implement public-service TimeNodes. A wallet provider may implement secure storage and API queries. The root protocol remains the same: time anchor, behavior vector, identity context, composite signature, proof, conditioned issuance, storage, and synchronization.

Each layer may be implemented by separate parties or a single platform. The claims do not require separation of layers. However, describing layers clarifies technical boundaries and assists interoperability. For example, a third-party wallet may implement only secure storage and Time Sync verification; an institutional server may implement proof verification; a local device may implement signal capture and initial signature generation; a regional TimeNode may synchronize commitments.

### Reference Data Objects

A Time-of-Time Anchor object may contain: anchorId, anchorClass, anchorSource, timeWindowStart, timeWindowEnd, sourceConfidence, sourceAttestation, relativeTimeReference, absoluteTimeReference, privacyLevel, and policyReference. A Behavior Vector object may contain: vectorId, eventClass, signalCommitments, sourceAttestations, timeWindow, roleMetadata, serviceCategory, behaviorCategory, confidenceScore, and featureCommitment. An Identity Context object may contain: identityRef, identifierType, walletRef, credentialRef, domainContext, nonDomainContext, deviceRef, attestationRef, consentState, and privacyScope.

A BEI-TSIG object may contain: signatureId, algorithmId, anchorRef, behavior VectorCommitment, identityContextCommitment, proofAttestationRef, nonce, issuerNode, proofPolicy, privacyScope, entropyScore, verificationStatus, issuanceState, and syncStatus. A time-certified asset object may contain: assetId, signatureRef, assetClass, usageCategory, ownerRef, walletRef, lifecycleState, rightsMetadata, beneficiaryRule, indexRef, exchange ValidationRef, auditRef, and synchronizationRef.

These objects can be represented as JSON, JSON-LD, CBOR, ASN.1, protocol buffer messages, database records, wallet objects, verifiable credential extensions, or ledger entries. The object definitions are non-limiting. Their purpose is to demonstrate sufficient structure for implementing the invention and for integrating with third-party systems.

### Reference Algorithmic Flow

In one non-limiting algorithm, the system receives raw event signals and identity inputs. The Time-of-Time Anchor module derives an anchor. The signal fusion engine validates sources, filters noise, normalizes features, computes confidence values, and forms a Behavior Vector. The identity context generator binds a subject, device, wallet, domain, credential, or non-domain identifier. The signature generator combines the anchor, Behavior Vector, identity context, proof attestation, and nonce. The verifier checks the SceneKey and proof policy. Privacy and zero-knowledge routines verify predicates. Entropy routines detect replay or synthetic behavior. The BEIMINT state machine conditionally issues or updates an asset. The wallet stores the asset. TimeNodes synchronize the verification state.

Pseudocode may be implemented as follows: receive rawSignals; receive identityInputs; TA=Anchor(rawSignals.timeSources, policy); BV=Vectorize(rawSignals, TA.window); IC=BuildContext(identityInputs); PA=Attest(rawSignals.sources, identity Inputs); N=Nonce(TA, IC, priorState); TSIG=H(TA∥BV∥IC∥PA∥N); proofStatus=VerifySceneKey(TSIG, BV, IC, policy); privacyStatus=VerifyZK(TSIG, proofRef); entropyStatus=EntropyCheck(BV, IC, priorState); if all status values pass, then issue asset and synchronize; otherwise reject, mask, or audit.

This reference flow is illustrative. A deployment may perform device-side signature generation, server-side proof verification, wallet-side storage, and node-side synchronization. Another deployment may run all steps locally. Another may use a secure enclave or HSM for signature generation. The claims protect the root technical pathway rather than one deployment topology.

### W3C DID and Verifiable Credential Interoperability

The BEI Time Standard may interoperate with decentralized identifiers and verifiable credentials. A DID may identify a subject, issuer, wallet, device, or TimeNode. A verifiable credential may reference a BEI-TSIG, Time-of-Time Anchor, behavior proof, or time-certified asset. A verifiable presentation may disclose only a verification result or selected fields. This allows the system to integrate with existing digital identity infrastructure while adding BEI-specific time and behavior certification.

A non-limiting verifiable credential extension may include a credentialSubject containing timeAnchor, behaviorProof, signatureRef, walletRef, privacyScope, issuerNode, verificationPolicy, and syncStatus. The underlying raw signals need not be included. The proof section may include a signature by a TimeNode, device, issuer, or wallet. The credential may be revoked, masked, updated, or reissued according to lifecycle policy.

The system is not limited to W3C standards. The same functions may be implemented through proprietary credentials, certificates, wallet records, database records, ledger entries, or local signatures. Standards compatibility increases adoption and licensing value but is optional.

### Open API, SDK, and Wallet Integration Embodiments

A Time Sync API may expose endpoints such as createAnchor, submitBehaviorVector, generateSignature, verifySignature, issueAsset, storeAsset, syncState, query Verification, maskRecord, revokeRecord, indexRecord, and validateTransfer. These endpoint names are illustrative. An implementation may use REST, gRPC, message queues, local calls, wallet protocols, DID resolver extensions, or embedded device calls.

An SDK may provide functions including normalizeSignals( ), buildBehaviorVector( ), buildIdentityContext( ), generateBEITSIG( ), verifySceneKey( ), verifyZKProof( ), checkEntropy( ), conditionallyIssueAsset( ), storeInTimeWallet( ), and sync With TimeNode( ). A wallet provider could integrate only the verification and storage functions. A healthcare system could integrate only institutional proof and TimeNode functions. An exchange could integrate only validation functions.

By providing a clear integration pathway, the patent can support API licensing and SDK licensing. The technical benefit is that downstream systems do not need to recreate the root proof pipeline; they can call the standard functions or implement them under license while preserving privacy and interoperability.

### Healthcare and Care Time Certification Embodiments

In a healthcare embodiment, a provider may certify care time without revealing diagnosis or treatment details. Signals may include caregiver identity, institutional credential, time window, device event, patient consent state, service type, and privacy policy. The Behavior Vector commits to service occurrence and proof strength. The BEI-TSIG binds the time, care behavior, identity context, and attestation. BEIMINT conditionally issues a care-time asset or record. TimeNodes verify the result for authorized parties.

In an eldercare embodiment, family care time may be recorded through a mobile device, wearable device, family ReadName, institutional service record, or home care sensor. Raw personal details may remain local. A family TimeVault may store masked care-time assets and beneficiary rules. The record may support family recognition, reimbursement verification, long-term care documentation, or asset-package aggregation, depending on policy.

In a public health embodiment, regional TimeNodes may synchronize aggregated commitments rather than raw records. This permits verification of care capacity, service time, or public response time while preserving privacy. The system therefore supports both personal dignity and institutional accountability.

### Education, Learning, and Professional Certification Embodiments

In an education embodiment, a learning event may be certified by identity credential, attendance record, learning platform event, communication session, device signal, and time window. The system can generate a BEI-TSIG proving that a learning event occurred under a specific identity and time context. A Time Wallet may store learning-time assets or records. A school or credential provider may verify the record through Time Sync API without exposing private learning content.

In a professional certification embodiment, training time, continuing education, clinical training, engineering supervision, or professional service may be certified as time-certified records. The Behavior Vector may include skill type, service type, credential reference, institution reference, and time window. A professional wallet may accumulate verified service and learning records. An index endpoint may generate contribution or training scores as optional outputs.

This embodiment demonstrates that the system is not limited to currency or payment. It provides a technical certification infrastructure for human time and professional activity. This strengthens patent eligibility by focusing on secure verification and distributed synchronization.

### Work, Labor, Service, and Human-In-the-Loop AI Embodiments

In a labor or service embodiment, the system may certify work time, task time, maintenance time, care time, review time, or supervision time. Signals may include workstation events, mobile device attestations, institutional records, geolocation, task records, communication events, and identity credentials. The BEI-TSIG binds these signals to a time anchor and context.

In a human-in-the-loop AI embodiment, a person may supervise, validate, correct, or approve AI outputs. The system may certify that human time was actually involved rather than synthetic activity. Entropy anti-spoofing can evaluate interaction cadence, device attestation, response patterns, and identity context. A time-certified asset or record may be issued to represent verified human review time.

This embodiment is increasingly important where AI can generate synthetic behavior. The system distinguishes real human time from machine-generated activity by requiring composite behavioral proof, privacy-preserving verification, and TimeNode synchronization.

### Device, IoT, Edge, and Offline Embodiments

In a device embodiment, a wearable, mobile phone, medical device, industrial sensor, vehicle device, home device, or embedded controller may act as a signal source. The device may provide a secure element identifier, TEE report, device public key, sensor signal, and local clock. The signal fusion engine may run locally or at an edge node.

In an offline embodiment, a local device may generate an initial BEI-TSIG and store it with a local Time-of-Time Anchor. When connectivity becomes available, the record may be synchronized with TimeNodes. The Time Sync API may mark the record as delayed, locally attested, or later synchronized. This supports disaster areas, remote care, field work, rural deployments, and other intermittent environments.

In an IoT resource embodiment, a device event may represent use of energy, bandwidth, compute time, machine time, transportation time, or service time. The system may treat such events as device-associated time records, but a human identity context may be required when human time certification is needed. The claims are not limited to human-only signals, but the BEI root standard is optimized for certified human time and behavioral identity.

### Domain, ReadName, and Non-Domain Identifier Embodiments

Domain names may provide memorable identity, service, wallet, minting, index, or exchange endpoints. A ReadName may be implemented through a domain or subdomain. A TimeID may be implemented through a domain, DID, public key, or wallet address. The domain fabric prepared over many years may support structured deployment for persons, families, industries, institutions, regions, nations, and international organizations.

However, the invention does not require domains. The same identity or endpoint functions may be implemented with DIDs, public keys, wallet addresses, blockchain addresses, device identifiers, HSM identifiers, TEE attestations, verifiable credential references, OIDC identifiers, QR codes, NFC tags, API endpoints, edge node identifiers, offline keys, or embedded identifiers. This prevents easy design-around by replacing a domain with another identifier.

Domain examples in the disclosure are therefore deployment examples and asset-package examples. They help demonstrate ecosystem use but do not limit the technical claims. The technical root is the BEI Composite Time Signature and the verification pipeline.

### Index, Exchange, and Licensing Verification Embodiments

An index endpoint may compute a TimeIndex, BEIIndex, behavior index, contribution score, identity index, care index, education index, service index, or regional index. The index endpoint may use only verified signatures or masked proof results. It may not require raw personal data. This allows time records to contribute to analytics and asset packages while preserving privacy.

An exchange endpoint may require verification before transfer, listing, authorization, or settlement. The exchange endpoint may submit a VerifySignatureRequest to the Time Sync API and receive a verification status. The endpoint does not need to know the full raw behavior data. Thus, the patent protects the verification toll booth that downstream systems must use to treat a time-certified asset as valid.

A licensing endpoint may issue API keys, SDK access, TimeNode credentials, wallet integration permissions, index permissions, or asset-package sublicenses. Such licensing functions are optional commercial embodiments. The claims do not require a particular business model, but the technical interfaces support practical licensing.

### Prior System Comparison Implementation Details

A conventional timestamp system records a time associated with data. It does not, by itself, create a Behavior Vector, SceneKey, identity context, entropy proof, conditioned issuance state, Time Wallet lifecycle metadata, or TimeNode synchronization state. The BEI Time-of-Time system uses time as one component in a composite proof, not as the entire proof.

A conventional proof-of-attendance system may record presence at an event. It does not necessarily bind life-time or behavior-time to a BEI identity, generate a Time-of-Time anchor, fuse domain or non-domain identifier context, verify privacy-preserving behavioral proof, conditionally issue a time-certified asset, and synchronize through TimeNodes. The present system is therefore broader in technical architecture while being more specific in signature generation.

A proof-of-personhood system may verify a person at a point in time. It does not necessarily certify repeated behavioral-economic identity time, service events, family care time, learning time, institutional time, or contribution time as synchronized assets. The BEI system certifies time events rather than merely personhood.

A conventional token minting system may mint tokens based on rules. The BEIMINT module performs conditioned cryptographic issuance only after composite signature verification, behavioral proof, privacy verification, and entropy checks. This is a technical state transition, not a mere reward rule.

A conventional DID or wallet system may identify and store records. The BEI system uses identity and wallet components as parts of a larger time-certification standard. The wallet stores records generated by a time-behavior-identity proof pipeline and synchronized by TimeNodes.

### Civilizational Infrastructure Embodiments

The BEI Time-of-Time system may be used by individuals to certify personal time, by families to preserve care and inheritance records, by industries to standardize service and training time, by institutions to verify professional or public service time, by regions to maintain time-based public records, by national systems to coordinate verified contribution records, and by international institutions to verify cross-border time-based services while preserving privacy.

The system is not a declaration or policy. It is a technical infrastructure that can be adopted by different communities. Each adopter may use local identifiers, local policies, local wallets, and local TimeNodes while sharing the root BEI-TSIG structure and Time Sync verification interface. This is how the invention can function as a civilization-scale economic foundation without requiring a single central authority or uniform domain system.

The invention may support a long time horizon. Human time records may survive device changes, wallet changes, domain changes, institutional changes, or national boundaries because the root proof can be represented as a signature, commitment, wallet record, and TimeNode synchronization record. This supports use over years, generations, and institutional transitions.

### Detailed Portfolio Boundary Implementations

The root patent protects the BEI Time-of-Time pipeline. A separate financial clearing patent may protect clearing houses, ISO messages, CBDC rails, fiat rails, or regulatory audit interfaces. A separate valuation patent may protect specific coefficient models, F2400/T1NV/CPV8 formulas, decay formulas, parity formulas, or index calculations. A separate domain routing patent may protect domain rings, endpoint routing, DNS-oracle mechanisms, or domain-resolution governance. A separate payment ring patent may protect payment loops, settlement rings, or royalty settlement. These downstream areas may interoperate with the root but are not required by the root claims.

This boundary reduces overlap while increasing overall asset value. A licensee may license only the root verification pipeline, or may license root plus wallet, root plus index, root plus exchange, root plus clearing, root plus domain routing, or the full asset package. The patent family thus provides modular licensing packages rather than a single overbroad claim set.

The 950 v2 application should therefore avoid claiming detailed TCH, ISO 20022, CBDC, DomainRing, TimeRing, CPV8, or payment settlement mechanisms in independent claims. It should disclose optional interoperability while preserving the root focus.

### Additional Enablement and Implementation Support

The system claim is supported by the modular architecture described in the summary, definitions, signal fusion, signature generation, behavioral proof, privacy, BEIMINT state machine, Time Wallet, and Time Sync sections. The method claim is supported by the reference algorithmic flow and state transition descriptions. The CRM claim is supported by the software, SDK, API, wallet, edge node, server, and embedded device embodiments.

For enablement, the specification provides representative data objects, pseudocode, formula examples, API request-response fields, signal normalization steps, state machine states, and implementation examples. These support construction of the claimed system without undue experimentation while allowing implementation flexibility.

For definiteness, the specification defines terms such as Time-of-Time Anchor, BEI, Behavior Vector, BEI Composite Time Signature, SceneKey, Privacy Filter, Entropy Anti-Spoofing, BEIMINT, Time Wallet, TimeNode, Value Aggregation Vault, and Undeveloped Behavioral-Economic Namespace. These definitions reduce ambiguity while preserving broad but definite scope.

### Additional Drawing Description Embodiments

FIG. 5 is the heart of the invention. It should show Time-of-Time Anchor, Behavior Vector, Identity/Domain/Identifier Context, Device/Proof Attestation, and Nonce as separate inputs to a hash or signature engine. The output should be BEI Composite Time Signature. Arrows should contact the boundary of each box without entering text. The figure should include reference numerals for each input and output.

FIG. 8 should show the BEIMINT state machine as technical states rather than a money minting diagram. Representative states may include Unverified, Time-Anchored, Proof-Verified, Time-Certified, Issued, Stored, and Synchronized. This supports § 101 by showing a technical state transition rather than an abstract transaction.

FIG. 10 should show a verification request-response interaction. A verifier submits a request through Time Sync API to one or more TimeNodes. The TimeNodes return a verification status, confidence, audit reference, and masking state. This figure supports the licensing value of verification rights.

### Additional Technical Protocol Details and Non-Limiting Deployment Examples

The following additional detail further supports operation of the BEI Time Standard in practical environments. These embodiments emphasize protocol clarity, long-term utility, interoperability, security, privacy, and asset-package value while preserving the root distinction between the claimed time-certification layer and optional downstream systems.

### Secure Hardware and Attestation Embodiments

A secure hardware embodiment may use a secure element, trusted execution environment, hardware security module, biometric sensor, medical sensor, wearable sensor, mobile device, or edge node to generate or protect one or more inputs to the BEI Composite Time Signature. The secure hardware may sign a device attestation, store a private key, generate a nonce, confirm a sensor source, or protect a local Time-of-Time Anchor. Such hardware can increase confidence but is not required in every embodiment.

A trusted execution environment may generate an attestation report indicating code identity, device state, time source, sensor permissions, and key status. The attestation report may be used as Device/Proof Attestation in the BEI-TSIG formula. A hardware security module may sign TimeNode synchronization commitments. A secure element may bind a wallet to a device. These mechanisms reduce spoofing and strengthen verification without requiring any one hardware vendor.

In deployments without secure hardware, institutional proof, multi-factor credentials, network proofs, or other source attestations may be used. The invention is therefore flexible across high-assurance medical, financial, and governmental environments as well as ordinary mobile or web environments.

### Synthetic Behavior and AI-Generated Activity Detection

The system may detect synthetic behavior generated by scripts, bots, AI agents, replay tools, or simulated device signals. Synthetic behavior detection may compare behavior density, response timing, device motion, signal diversity, location continuity, identity consistency, service context, and prior event history. A pattern that is too regular, too dense, inconsistent with physical movement, inconsistent with service context, or inconsistent with identity history may be flagged.

An AI-generated communication event may have text or interaction patterns that do not align with device telemetry or human timing. A fake attendance event may have a credential but lack location, device, or interaction evidence. A repeated service claim may reuse a Behavior Vector or nonce. The entropy anti-spoofing module can detect these conditions and prevent the BEIMINT state machine from advancing to Time-Certified.

This capability is important because future digital systems will increasingly need to distinguish authentic human time from synthetic activity. The invention does not claim to detect every AI system; rather, it provides a technical proof pipeline that requires time, behavior, identity, context, and anti-spoofing evidence before a time-certified asset is generated or verified.

### MULTI-NODE SYNCHRONIZATION AND CONSENSUS VARIATIONS

A TimeNode may verify a BEI-TSIG independently or as part of a distributed synchronization process. In one embodiment, each TimeNode stores a commitment to a signature and a verification state. Nodes exchange commitments, synchronization receipts, and audit hashes. If two nodes disagree, the system may mark the record as disputed, require additional proof, or preserve both states until resolved by policy.

TimeNodes may be organized by family, institution, region, industry, country, international organization, private service, or edge network. A node may be authoritative for a local domain, a particular service category, a credential issuer, a wallet network, or an index service. The root protocol permits a federation of nodes without requiring a single central authority.

Synchronization may use push, pull, batch, event-driven, periodic, or offline-to-online methods. A mobile device may store records until a network returns. A remote clinic may batch synchronize care records. A school may synchronize daily learning records. A regional node may aggregate masked commitments. These variations demonstrate real-world utility across environments.

### Interoperability with Traditional Databases and Enterprise Systems

The BEI Time-of-Time system may interoperate with traditional databases, enterprise resource planning systems, human resource systems, healthcare record systems, learning management systems, customer relationship management systems, supply chain systems, and government record systems. Such systems may store existing event data, while the BEI system provides a cryptographic time-behavior-identity certification layer.

For example, an enterprise database may store work orders. The BEI system may certify the human supervision time associated with those orders. A hospital record system may store patient data, while the BEI system stores only privacy-preserving proof that a care event occurred. A learning platform may store course activity, while the BEI system stores verified learning time commitments.

This interoperability increases licensing value. The invention is not limited to blockchain-native systems; it can function as a root time-certification layer for legacy infrastructure. A licensee may integrate the Time Sync API with existing systems without replacing those systems.

### National, Regional, and International Node Governance Implementations

A national or regional deployment may operate TimeNodes for public service records, healthcare workforce records, education records, emergency response records, volunteer service records, public infrastructure service records, or industry certification records. The TimeNodes may store masked commitments and verification states rather than raw personal data. Local rules may control disclosure and audit.

An international organization may operate or coordinate TimeNodes for humanitarian service, cross-border medical response, public health programs, development projects, education programs, climate response, or disaster recovery. A common BEI Time Standard interface allows different jurisdictions to verify time events without adopting one currency, one wallet, one domain, or one central database.

Governance is not a claim limitation. Each deployment may define its own credential issuers, privacy scopes, node operators, audit policies, and interoperability rules. The claimed root technology supplies the BEI-TSIG and verification pipeline that can be used under different governance arrangements.

### BEI Index and Time Index Technical Outputs

An index output may be generated from verified signatures and assets. An index may count verified time, categorize service time, score contribution consistency, measure care intensity, measure learning time, compute a regional service capacity, or generate an institutional compliance indicator. Such index outputs are optional downstream products.

An index endpoint may use only masked inputs. For example, a TimeIndex can count verified care hours without revealing patient identities. A BEIIndex can compute contribution categories without exposing raw behavior. A regional index can aggregate public service time commitments from multiple TimeNodes. The system thereby supports analytics without sacrificing privacy.

The root patent should not claim a particular index formula as required. Specific formulas can be protected by separate valuation or index patents. The 950 root claim should protect the verified signature and synchronization records that make trustworthy indexing possible.

### Exchange, Transfer, and Authorization Technical Outputs

A downstream exchange endpoint may use a verification status before accepting an asset for transfer, listing, licensing, access authorization, or settlement. The endpoint may not need to know raw personal data. It may only need to know whether the BEI-TSIG is valid, whether the asset is current, whether the wallet has rights, and whether privacy rules permit the transaction.

An authorization endpoint may use a time-certified asset as a credential for access. For example, a professional may prove recent verified service time, a student may prove verified learning time, a caregiver may prove care time, or a device operator may prove supervised operation time. The Time Sync API can return a verification status without exposing raw records.

These downstream uses increase commercial value but should remain optional in the claims. The root invention is the verification path that downstream systems use. This prevents the claims from becoming a mere exchange or market claim.

### Family and Intergenerational Time Records

Family deployments may preserve care, support, education, health, and household service time. A family TimeVault may store records associated with multiple identities, roles, and beneficiaries. A parent, child, caregiver, elder, guardian, or family institution may be associated with different access policies. The system can preserve verification while hiding sensitive family details.

Intergenerational records may use life-origin time anchors, family ReadNames, beneficiary rules, and inheritance metadata. A record can remain verifiable even if raw signals are later masked. This supports long-term continuity and asset-package value. The technology does not require any one legal inheritance system; it implements technical access and verification rules.

Family deployments show why Time of Time is not only a business tool. It can create durable records of human care and contribution across time. The patent captures the technical root required to verify such records.

### Medical, Emergency, and Public Service Time Records

Medical and emergency contexts require privacy, reliability, and auditability. A care event may require institutional credential proof, role proof, time window, device proof, and privacy mask. An emergency response event may require location, timestamp, responder identity, device proof, and agency node verification. The BEI-TSIG binds these elements while preserving privacy.

A TimeNode operated by a medical center, emergency service, public health institution, or regional authority may verify records. Domains such as 120.us or medicalcenter.us may serve as non-limiting endpoints, but the system may also use institutional DIDs, public keys, device identifiers, or private APIs. The core proof pipeline remains domain-independent.

This embodiment demonstrates use by institutions and public service systems. It supports long-term value because healthcare and emergency time are among the most socially significant forms of human time.

### Education, Research, and Continuing Professional Education Records

Education deployments may certify learning time, teaching time, mentoring time, clinical training, research supervision, conference participation, continuing professional education, or institutional service. Signals may include attendance, communication, learning platform events, device proof, credential proof, and time window.

A professional education provider may issue a verifiable record of time-based participation. The BEI system can protect privacy while allowing institutions to verify compliance. A student or physician may store records in a Time Wallet. A licensing body may query a Time Sync API for verification status.

This embodiment connects the invention to practical professional use. It also supports asset package value because education, certification, and professional time verification are large markets requiring trustworthy records.

### Domain Fabric as Deployment Soil, not Claim Limitation

The domain infrastructure described in this specification provides one deployment soil for the BEI Time Standard. It can organize personal, family, industry, regional, national, international, emergency, healthcare, education, wallet, minting, index, exchange, and time-unit endpoints. It provides continuity and naming persistence, especially when prepared over many years.

However, the domain fabric is not the invention itself. The invention is the technical pathway that converts a Time-of-Time anchor, Behavior Vector, and identity or identifier context into a BEI Composite Time Signature and uses that signature to gate conditioned issuance, storage, synchronization, and verification. Any domain examples are illustrative and non-limiting.

This distinction prevents design-around and avoids over-limiting the claims. A competitor cannot avoid the root claims merely by replacing a domain name with a DID, public key, wallet address, QR code, device identifier, or API endpoint if the same BEI-TSIG and conditioned verification pipeline is used.

### Transaction, Transfer, and License Pack Examples

A license package may include the right to generate BEI-TSIG signatures, the right to verify signatures through Time Sync API, the right to operate TimeNodes, the right to integrate Time Wallet storage, the right to index verified time assets, or the right to validate exchange transfers. Different licensees may obtain different rights. This supports modular commercialization.

A transfer package may include a TimeVault, domain endpoints, wallet records, index records, API schemas, SDK code, TimeNode operation rights, and related patent rights. The root patent increases value because it defines the common verification layer across these assets.

An asset package may include the root 950 patent together with downstream financial clearing, valuation, domain routing, and payment settlement patents. The root patent makes the package stronger because downstream systems can be positioned as using or extending the root BEI Time-of-Time infrastructure.

### Formal Non-Limitation of Cultural and Historical Terms

The disclosure includes historical and linguistic background concerning time, BEI, Bei, shells, value, currency, Time of Time, life-origin time, organic domain fabric, Value Aggregation Vault, and Undeveloped Behavioral-Economic Namespace. These terms provide context and naming continuity. They do not limit the technical scope unless expressly recited in a claim.

For example, the Chinese character Bei and the inventor's surname may explain naming origin, but the system can be used by any person, family, industry, region, nation, or institution. The life-origin time example may include fetal movement, but the system can use many other anchor sources. Domain examples may show deployment history, but the system can operate without domains.

This balance preserves the distinct BEI character while maintaining patent clarity and broad technical applicability.

### Supplemental Figure Support for USPTO Drawing Practice

Drawings should use black line art, consistent line weight, clear reference numerals, and arrows that touch the edge of boxes rather than entering text. Boxes should contain concise technical labels. Long explanations belong in the specification, not inside drawings. Each drawing should show one core relationship.

FIG. 5 should be treated as the principal technical figure. It should show five input boxes feeding a signature engine: Time-of-Time Anchor, Behavior Vector, Identity/Domain/Identifier Context, Device/Proof Attestation, and Nonce. The output should be BEI Composite Time Signature. This figure directly supports independent claims.

FIG. 8 should show the state machine. This supports eligibility by showing a technical transition rather than a business act. FIG. 10 should show the verification request-response. This supports licensing value by showing a verifiable API interface that downstream systems call.

### Supplemental Civilization-Scale and Asset-Package Implementation Embodiments

The following embodiments further illustrate how the BEI Time-of-Time root infrastructure may remain technically concrete while serving long-term personal, family, industry, regional, national, international, licensing, and asset-package use cases. These embodiments do not broaden the claims beyond the root technical pipeline; rather, they provide examples of how the claimed modules may be used in practical systems.

### Personal Time Sovereignty Embodiments

An individual may use the BEI Time-of-Time system to certify personal time events that would otherwise be invisible to ordinary financial, identity, or credential systems. Examples include caregiving, learning, rehabilitation, volunteer service, mentoring, creative labor, medical self-care, community participation, and verified communication. The system does not assume that all personal time must become transferable or public. It permits selective certification, storage, masking, verification, inheritance, or index use according to policy.

The individual's Time Wallet may include different compartments. A private compartment may store raw or locally encrypted proof references. A shareable compartment may store masked verification outputs. An index compartment may store aggregated scores. An inheritance compartment may store beneficiary rules. An exchange or licensing compartment may store records that the user permits to be validated by downstream systems. These compartments can be implemented as separate data structures or as metadata states within one wallet.

This personal use case demonstrates why BEI is not merely identity. A person is not only a login account; a person is a time-bearing and behavior-bearing subject whose verified activities can be certified in a privacy-preserving manner. The Time-of-Time anchor and BEI-TSIG provide the technical bridge between lived time and digital verification.

### Family and Household Economic Time Embodiments

A family may use the system to certify household care, elder care, child care, education support, health support, emergency response, family service, and intergenerational contribution. Such time is often economically meaningful but not captured by conventional wage, bank, or credential systems. The BEI Time-of-Time system can generate privacy-preserving signatures for these activities and store them in a family TimeVault.

Family roles may be represented as role metadata. A parent, child, caregiver, elder, guardian, sponsor, trustee, beneficiary, or institution may have different access permissions. A family wallet may require multi-signature attestation for transfer or disclosure. A family TimeNode may synchronize with healthcare or education TimeNodes while preserving masked proof. These are technical access-control and synchronization features, not abstract family policy.

In a long-term family archive, time-certified records may remain verifiable after decades even if raw signals are removed or masked. The system can preserve proof references, wallet state, anchor references, and audit hashes. This supports the concept of time as a durable family asset without requiring any particular legal regime.

### Industry-Wide Time Standardization Embodiments

An industry association may adopt a BEI Time Standard to certify training time, safety time, apprenticeship time, professional service time, maintenance time, supervision time, research time, or compliance time. Each company may operate its own systems while using a shared BEI-TSIG structure. Industry TimeNodes may verify masked commitments from member organizations.

For example, a medical industry node may verify care time and continuing education. An engineering industry node may verify training and supervision. A construction industry node may verify safety training and service hours. A legal or accounting industry node may verify continuing professional education. Each deployment may use local credentials, but the BEI-TSIG structure remains the common root proof.

This industry standardization creates licensing value because implementation requires a consistent API, signature generation, verification, and synchronization path. The patent can support SDK licensing, node licensing, and certification licensing without claiming a particular industry business model.

### Government and Public Infrastructure Embodiments

A public institution may use BEI Time-of-Time records for emergency response, public health service, education service, volunteer service, civil service, eldercare, childcare support, workforce training, disaster recovery, and infrastructure maintenance. The system can generate records that are auditable and privacy-preserving. Public systems may use regional TimeNodes and standardized verification requests.

A government or region need not operate a currency or exchange to use the invention. It can use the root layer to verify time, behavior, identity context, and proof status. The system can coexist with existing public databases by adding a cryptographic certification and synchronization layer. This avoids overclaiming while demonstrating practical public utility.

Public infrastructure embodiments may also use time-unit endpoints, regional identifiers, institutional credentials, secure hardware, and masked audit records. The Time Sync API can allow authorized agencies to verify records without seeing raw personal content. This makes the system suitable for privacy-sensitive public use.

### International and Cross-Border Embodiments

An international institution may require verification of humanitarian service, medical response, education programs, disaster relief, development projects, research collaborations, or cross-border workforce time. Different countries and organizations may use different identity systems. The BEI Time-of-Time system can operate as a neutral technical layer by permitting domain and non-domain identifiers and by using privacy-preserving proofs.

In a cross-border deployment, a TimeNode in one region may verify a signature generated in another region by checking signature commitments, issuer node credentials, privacy scope, and proof references. Raw data may remain local. A regional index may receive aggregated commitments. An international organization may receive verification status only. This supports sovereignty and privacy while enabling interoperability.

The invention therefore can be framed as infrastructure that every person, family, industry, region, nation, and international institution can use according to its own policies. The root technical features remain the same even when governance varies.

### Standards Adoption and Frand-Style Licensing Embodiments

The BEI Time Standard may be adopted as an open technical interface while patent rights are licensed under appropriate terms. A standards-compatible embodiment may define data objects, API endpoints, verification response fields, node credential formats, wallet integration routines, and privacy scopes. The patent does not require a standards organization, but the specification enables standards-oriented deployment.

A FRAND-style licensing embodiment may allow wallet providers, DID platforms, healthcare systems, education systems, industry bodies, regional TimeNodes, exchange validators, and index providers to implement the Time Sync API and BEI-TSIG verification process. Licensing may be per API call, per node, per institution, per SDK, per wallet integration, per asset package, or per region.

The highest licensing value is not only in generating time-certified assets; it is in verifying them. Any downstream system that wants to trust a human time record must query or reproduce the verification path. This creates a durable toll booth while keeping the root patent technically focused.

### Asset Package Valuation Embodiments

An asset package may include patent rights, domain endpoints, trademarks, software prototypes, SDKs, API schemas, TimeNode implementations, wallet implementations, index models, exchange validators, and documentation. The root patent increases package value because it defines the essential verification layer tying these assets together. Without the root layer, downstream assets may appear as separate applications. With the root layer, they become a protocol family.

Valuation may be supported by mapping each downstream system to the root pipeline. BEIMINT uses conditioned issuance. BEIWALLET stores Time Signatures and assets. BEIIndex and TimeIndex consume verified signatures. BEIGX, BEISX, BEICX, and BIZX validate assets before transfer or listing. Domain identity systems provide endpoints. TimeDomain and TimeRing systems provide downstream routing or settlement. The root patent ties them together.

This specification should not state a monetary valuation, but it can describe technical interoperability and licensing embodiments. Asset package materials outside the patent may state that the root patent is the choke-point layer for the BEI Time Standard ecosystem.

### Cross-Protection with Retained Applications

To avoid excessive overlap, the root application should not claim detailed downstream clearing, valuation, domain-ring routing, or payment-ring settlement. Instead, it should disclose optional interoperability with such layers. This preserves room for related retained applications to protect the financial clearing layer, valuation metering layer, domain routing layer, and payment settlement layer.

The root layer can be licensed with downstream layers. A licensee seeking only verification may license the root. A licensee seeking financial clearing may need root plus clearing. A licensee seeking valuation may need root plus valuation. A licensee seeking domain routing may need root plus domain routing. This creates cross-portfolio leverage and reduces the risk that one patent must do everything.

The specification therefore should repeatedly identify downstream systems as optional and external. This protects the root while respecting the separate value of related applications.

### Hard Claiming without Losing Bei Character

The claims should remain technical and concise. The independent claims should not recite cultural history, domain lists, exchange names, valuation rhetoric, or global policy objectives. They should recite Time-of-Time Anchor, signal fusion, Behavior Vector, identity context, BEI Composite Time Signature, behavioral proof, privacy or zero-knowledge verification, entropy anti-spoofing, BEIMINT conditioned issuance, secure storage, and Time Sync API.

The specification should preserve BEI character. It should define BEI, Time of Time, BEIMINT, TimeCoin, TimeCurrency, BEI Currency, BI Currency, ReadName, TimeID, organic domain fabric, Value Aggregation Vault, and Undeveloped Behavioral-Economic Namespace. This creates a personalized and distinctive invention while keeping the claims acceptable.

This division preserves both technical precision and the distinctive BEI Time-of-Time architecture. The claims identify the root technical pathway, and the specification describes the broader BEI ecosystem as non-limiting embodiments.

### Additional Enablement Examples for Section 112

Enablement is strengthened by providing multiple concrete examples rather than broad assertions. The specification should include examples for a sensor-based event, an institutional record event, a wallet-only event, a privacy-sensitive healthcare event, an education event, an offline device event, a family inheritance event, an index event, and an exchange validation event. Each example should show the time anchor, behavior vector, identity context, proof, signature, issuance, storage, and synchronization steps.

For a sensor-based event, raw acceleration or biometric data is sampled, filtered, committed, and converted into a vector. For an institutional event, a signed credential or record is transformed into a proof reference. For a privacy-sensitive event, only a zero-knowledge predicate is shared. For an exchange event, only verification status is returned. These examples allow a skilled person to implement the invention across different inputs.

The claims need not recite every example. The examples support breadth and reduce risk of enablement challenges.

### Additional Distinctions Over Prior Art

The system differs from time banking because it does not merely credit hours; it generates cryptographic BEI-TSIG signatures and synchronized verification states. It differs from proof of attendance because it verifies behavior, identity context, privacy proof, and state transition. It differs from proof of personhood because it certifies human time events, not merely identity. It differs from blockchain timestamping because time is only one component of a composite signature.

The system differs from behavioral biometrics because it does not only authenticate a user; it uses behavior evidence as part of a time-certified asset issuance and verification pipeline. It differs from ordinary token minting because issuance is conditioned on composite signature validity, SceneKey proof, privacy verification, entropy anti-spoofing, and TimeNode synchronization. It differs from ordinary wallets because wallets store lifecycle-managed time-certified records linked to BEI identity and Time Sync status.

These distinctions should be stated in the Technical Advantages section without disparaging specific products or making unsupported assertions. The key point is the integrated combination and the specific technical data path.

### Supplemental Claim Interpretation Support

The term conditioned issuance should be interpreted as a technical state transition that generates, updates, transfers, accumulates, or certifies a data unit only after verification conditions are satisfied. It does not require a currency, exchange, financial instrument, or securities transaction. This supports eligibility and broad applicability.

The term time-certified digital asset should be interpreted as a machine-readable record generated from or linked to a verified BEI-TSIG. It may be a token, credential, receipt, database record, wallet object, ledger entry, certificate, or encrypted archive. The term asset indicates technical record utility and does not require a financial classification.

The term BEI Composite Time Signature should be interpreted as a cryptographic representation binding time, behavior, and identity-context components. Domain context is optional and may be replaced by non-domain identifiers. This prevents limitation to domain names and prevents design-around through non-domain identity systems.

### Enduring Utility of the BEI Time Standard

The BEI Time Standard is designed for long-term use because human time remains a universal source of service, care, learning, labor, health, communication, and contribution. Technologies may change, but the need to verify authentic human time in privacy-preserving ways will remain. The root patent should therefore protect the abstracted technical pipeline rather than one platform.

A future wallet, AI system, robot, medical device, educational platform, industry node, national record system, or international institution may use different hardware and networks. If it binds a Time-of-Time anchor, behavior vector, identity context, proof attestation, and nonce into a composite signature and uses that signature to gate time-certified issuance or verification, it should fall within the intended root pathway.

This enduring utility supports use as a long-term civilization-economic foundation while keeping the claimed technology grounded in implementable computer, cryptographic, identity, wallet, and synchronization modules.

### Supplemental Implementation Tables and Extended Protocol Examples

This section provides additional non-limiting examples and implementation detail to support use by individuals, families, industries, regions, nations, and international institutions while keeping the core claim scope directed to the BEI Time-of-Time root pipeline.

### Example Event Classes and Proof Requirements

An event class may define proof requirements. A care event may require caregiver identity, care role, time window, service context, and privacy mask. A learning event may require learner identity, institutional credential, session context, and engagement signal. A labor event may require worker identity, task context, device or institution proof, and time window. A communication event may require sender or participant identity, message-session metadata, and time window. A device event may require secure element or TEE attestation. A public service event may require institutional node verification.

Each event class may map to a SceneKey policy. The policy may specify required signal types, minimum confidence, allowed identity types, privacy scope, entropy threshold, wallet storage rule, and TimeNode synchronization rule. For low-sensitivity events, a simple proof may be enough. For high-value or privacy-sensitive events, the system may require multiple proofs and zero-knowledge verification.

By defining event classes and proof requirements, the system can be standardized without becoming rigid. Each industry or institution can adopt its own policies while still using the same Time-of-Time Anchor, Behavior Vector, BEI-TSIG, and Time Sync structure.

### Example Privacy Scopes and Disclosure Levels

The system may define privacy scopes including private, family-visible, institution-visible, node-verifiable, index-eligible, exchange-verifiable, audit-only, and public-proof. A private record may remain in the wallet. A family-visible record may be accessible to approved family identities. An institution-visible record may be disclosed to an authorized institution. A node-verifiable record may return only verification status. An index-eligible record may contribute to aggregate scores. An exchange-verifiable record may permit transfer validation without raw data.

Disclosure level can be controlled by wallet policy, identity credential, asset state, time window, or regulatory context. A TimeNode may verify a signature but return only permitted fields. This supports selective disclosure and reduces unnecessary exposure.

These privacy scopes are not claim limitations but support practical use. They also show how the invention improves privacy and data minimization compared with systems that require a central database of raw behavior.

### Example Time Node Roles

TimeNodes may serve different roles. A user node may store personal records. A family node may coordinate family assets. An institutional node may certify service events. An industry node may verify professional standards. A regional node may aggregate public service commitments. A national node may coordinate authorized institutional records. An international node may provide cross-border verification. An audit node may verify masked records.

The same node may perform multiple roles. A healthcare institution may operate an institutional node and an audit node. A school may operate an education node. A wallet provider may operate a user node. A domain endpoint may route verification requests to a node. A device may act as an edge node for offline generation.

Defining node roles supports licensing and deployment. A license can be tied to node operation, API calls, SDK integration, or institutional verification. This strengthens commercial value while keeping the technical focus on synchronization and verification.

### Example Asset Metadata Profiles

An asset metadata profile may be selected based on event class. A care-time asset may include care category, caregiver role, beneficiary reference, privacy scope, and verification state. A learning-time asset may include course reference, institutional credential, learning window, and proof status. A labor-time asset may include task category, service type, institutional proof, and contribution score. A family-time asset may include family role, beneficiary rule, and inheritance metadata.

Each profile may include a signature reference, owner reference, wallet reference, lifecycle state, rights metadata, and TimeNode synchronization status. The profile may also include index eligibility, exchange eligibility, licensing permission, audit reference, and masking state. Not every asset requires all fields.

This flexible profile approach supports many uses while preserving a common root record structure. It allows downstream asset packages to organize records without changing the BEI-TSIG generation and verification path.

### Example API Message Lifecycle

A CreateTimeAnchor message may request generation of an anchor. A SubmitSignal message may submit raw or committed signals. A BuildBehaviorVector message may request normalization and vectorization. A GenerateSignature message may request BEI-TSIG computation. A VerifyBehavior message may request SceneKey and entropy checks. A ConditionIssue message may request BEIMINT state transition. A StoreAsset message may store records in a Time Wallet or TimeVault. A SyncRecord message may synchronize with TimeNodes. A VerifyRecord message may return verification status.

These message names are illustrative. A deployment may combine them into fewer calls or split them into additional calls. The key point is that the system exposes a standard interface for the root pipeline. This interface enables wallet providers, DID platforms, healthcare systems, education platforms, index services, and exchange validators to integrate with the BEI Time Standard.

API message lifecycles also support audit. Each message can be logged as a signed or hashed event, allowing later verification of when a signature was generated, when an asset was issued, when a wallet stored it, and when a TimeNode synchronized it.

### Example Technical Performance and Security Benefits

The root pipeline improves security by requiring multiple bindings before issuance: time anchor, behavior vector, identity context, proof attestation, nonce, behavioral proof, privacy verification, entropy check, and TimeNode synchronization. A false claim that lacks one or more of these bindings can be rejected. A replay attack can be detected by nonce or epoch. A synthetic behavior pattern can be detected by entropy. A privacy-sensitive event can be verified without raw content.

The system improves integrity by creating a signed or hashed record of the transition from unverified to time-certified. It improves interoperability by allowing many identifiers and standards. It improves durability by storing lifecycle and audit metadata. It improves privacy by masking raw content and returning verification status. These are technical improvements, not merely economic effects.

Security and performance benefits may vary by embodiment. The specification does not require a particular benchmark or numerical performance result. However, concrete modules and data structures support practical implementation and eligibility arguments.

### Example Standard Adoption Roadmap

A first adoption stage may define data objects: Time-of-Time Anchor, Behavior Vector, Identity Context, BEI-TSIG, time-certified asset, wallet record, and sync record. A second stage may define APIs for generating and verifying these objects. A third stage may define wallet and TimeNode conformance tests. A fourth stage may define optional index and exchange validation profiles. A fifth stage may define regional or institutional deployment policies.

This roadmap is not required by the claims. It demonstrates how the root patent can be used as a standard. Each stage can be licensed or adopted separately. An institution may adopt only anchor and signature generation. A wallet provider may adopt storage and verification. An index provider may adopt verification and aggregation. An exchange may adopt validation.

The roadmap helps show that the invention can become a practical standard rather than a one-off application.

### Example Civilization-Economic Root Infrastructure

The BEI Time-of-Time system can be understood as technical infrastructure for recognizing human time without reducing human time to a mere financial transaction. It gives individuals, families, industries, and institutions a way to certify time events, preserve privacy, and synchronize verification. It can support economic use, but the root invention is the certification and verification standard.

For every person, the system can certify life-time and contribution time. For every family, it can preserve care and inheritance records. For every industry, it can standardize service and training time. For every region or nation, it can verify public service and institutional contribution. For international bodies, it can provide cross-border verification. These uses are possible because the root pipeline is identifier-flexible and standards-compatible.

This infrastructure is long-term because time is universal, behavior is contextual, identity is needed, and privacy is essential. The patent should therefore protect the root pathway by which time becomes verifiable while avoiding over-dependence on any current platform.

### Final Non-Limiting Implementation Example

A user performs a care service event. A mobile device records a time window and device attestation. A care institution provides a credential reference. The signal fusion engine normalizes the device and institutional signals into a Behavior Vector. The identity module binds the user's BID, DID, ReadName, or TimeID. The Time-of-Time Anchor module creates an anchor. The BEI-TSIG generator computes a signature from the anchor, vector, identity context, attestation, and nonce. The verifier checks SceneKey policy, zero-knowledge proof, and entropy. BEIMINT changes the state to time-certified. The record is stored in a TimeVault and synchronized with TimeNodes. A future verifier receives a yes/no or confidence response without seeing raw care details.

A similar flow can support education, labor, communication, healthcare, public service, family records, regional service records, device events, and exchange validation. What changes is the event class and proof policy; the root pipeline remains the same.

This example shows the key claim concept in practical terms and ties together the major modules described throughout the specification.

### Additional Implementation Safeguards

The term Time-of-Time Anchor should be understood as a technical anchor object rather than a philosophical phrase. It may be instantiated as a data structure, hash commitment, signed certificate, ledger reference, wallet record, device attestation, institutional record, or verifiable credential reference. The anchor supplies a temporal input to the BEI Composite Time Signature and can be verified according to policy.

The term BEI Composite Time Signature should be understood as the technical heart of the system. It is not merely a label for a time record. It is the result of cryptographically binding at least a temporal component, a behavior component, and an identity or identifier context. Additional elements such as device attestation, proof attestation, nonce, privacy scope, or policy reference may increase assurance.

The term Behavior Vector should be understood as an engineered representation derived from raw or committed signals. A vector may be sparse, dense, binary, categorical, hashed, encrypted, or committed. It may be generated by deterministic rules or by a policy-controlled feature extraction process. It should be suitable for signature generation and verification without requiring disclosure of raw personal data.

The term conditioned issuance should be understood as a technical control gate. It prevents a record from becoming time-certified unless the system determines that a signature, behavior proof, privacy proof, and anti-spoofing check satisfy the applicable policy. In this way, the system improves data integrity and prevents false or duplicate time-certified records.

The term Time Wallet or TimeVault should be understood as a secure storage and policy enforcement node. It may be implemented as a software wallet, hardware wallet, secure database, encrypted vault, family wallet, institutional wallet, edge wallet, domain wallet, DID wallet, or hybrid storage node. It need not be a financial wallet.

The term TimeNode should be understood as a synchronization and verification node. It may be operated by a user, family, institution, industry, region, nation, international organization, wallet provider, index service, exchange validator, healthcare provider, education provider, or private service. It may synchronize commitments rather than raw records.

The system can be practiced in high-connectivity and low-connectivity environments. In high-connectivity environments, signatures and proofs may be synchronized immediately. In low-connectivity environments, signatures may be locally stored, later synchronized, and marked with a synchronization history. This supports remote, emergency, caregiving, and field deployments.

The system can be practiced with high-privacy and ordinary-privacy configurations. In high-privacy configurations, raw signals remain local and only commitments or zero-knowledge proofs are synchronized. In ordinary configurations, selected metadata may be shared according to policy. The claims do not require exposure of raw personal data.

The system can be practiced with domain-centric and domain-free identifiers. Domain-centric deployments may use memorable domains and subdomains for ReadName, TimeID, wallet, minting, index, or exchange endpoints. Domain-free deployments may use DIDs, public keys, wallets, QR codes, NFC tags, HSM identifiers, TEE reports, OIDC identifiers, or edge node identifiers. The same BEI-TSIG root logic applies to both.

The system can be practiced by different social units. A person may use it for personal time records. A family may use it for care and inheritance. An institution may use it for service and professional proof. An industry may use it for certification. A region or nation may use it for public service. An international body may use it for cross-border time verification. These examples demonstrate utility while remaining non-limiting.

The invention is intended to preserve a distinct BEI identity while satisfying technical patent requirements. Cultural, historical, and domain-related descriptions provide background and deployment context. The enforceable technical pathway is the Time-of-Time anchor, BEI Composite Time Signature, behavioral proof, privacy-preserving verification, conditioned issuance, secure storage, and TimeNode synchronization.

The described embodiments collectively provide a root standard for certifying human time. They allow time to be linked to behavior and identity in a way that can be verified, stored, synchronized, indexed, exchanged, licensed, or packaged as an asset without requiring a single central authority, single domain name, single wallet, single blockchain, single exchange, or single jurisdiction.

### Supplemental Practical Deployment Safeguards

In practical deployment, the system may implement audit levels. A low audit level may verify only signature existence. A medium level may verify signature existence, wallet state, and node synchronization. A high level may verify privacy proof, entropy score, issuer credential, and lifecycle policy. A regulator or institution may receive a higher level than an exchange or index service, depending on privacy policy and authorization.

The system may implement revocation and masking without destroying historical integrity. If a user withdraws consent or a policy changes, the raw content or selected metadata may be masked while the signature commitment, audit hash, and verification status remain available. This permits long-term proof without continuous exposure of personal content.

The system may implement portability. A user may migrate from one wallet to another, from one device to another, from one domain to another, or from one identifier system to another. The BEI-TSIG remains anchored to its Time-of-Time reference and identity context commitments, so later verification can proceed even after endpoint changes.

The system may implement federation. Multiple families, institutions, industries, regions, or nations may operate their own nodes and still verify shared signature formats. A federation does not require uniform business rules. It requires only compatible verification objects, proof policies, and synchronization messages.

The system may implement selective indexing. An asset may be index-eligible without being transfer-eligible. Another asset may be transfer-eligible but not public-index eligible. A third asset may be audit-only. These distinctions are technical metadata states that downstream systems can enforce through Time Sync API responses.

The system may implement proof freshness rules. A verification request may require a fresh node receipt, a recent wallet state, a non-expired proof, or a current credential. The response may indicate stale, current, revoked, masked, expired, disputed, or verified. This supports reliable use in high-value settings.

The system may implement domain continuity and non-domain resilience. A domain endpoint may be useful for naming and ecosystem organization, while a DID, public key, wallet address, HSM identifier, TEE report, or offline key may preserve continuity if a domain changes or is unavailable. This strengthens long-term reliability.

These safeguards demonstrate that the BEI Time-of-Time system is not a single application. It is a durable technical framework for certifying human time, preserving privacy, supporting identity mobility, enabling node federation, and providing verification interfaces for long-term civilization-scale use.

The root standard may also support archival verification. A long-term archive may preserve anchor commitments, signature commitments, node receipts, wallet state transitions, and policy hashes even after raw data is destroyed, expired, or masked. This permits future verification of a past time event without continuous possession of sensitive content.

The root standard may support independent implementation by multiple vendors. One vendor may provide signal capture, another may provide wallet storage, another may operate TimeNodes, and another may provide index or exchange verification. Because the BEI-TSIG and Time Sync objects are defined, vendors can interoperate without becoming the same platform.

The root standard may therefore function as a technical public-good layer while still supporting licensing of patented implementations. It creates a common route through which verified human time can be certified, protected, synchronized, and used by downstream systems without losing the distinct BEI Time-of-Time origin and identity.

The BEI Time Standard may also define conformance levels. A basic conformance level may generate and store BEI-TSIG records. An intermediate level may support Time Sync verification and privacy masking. An advanced level may support zero-knowledge verification, entropy anti-spoofing, lifecycle metadata, and institutional TimeNode synchronization. These levels can assist adoption without limiting the claims.

Conformance levels may be useful for licensing and standards adoption. A small family wallet may implement a basic level, a healthcare institution may implement an advanced privacy level, and an exchange validator may implement a verification-only level. Each level remains connected to the same root signature and verification model.

The described root standard therefore permits gradual adoption while preserving one coherent BEI Time-of-Time pathway. This is important for long-term deployment across individuals, families, industries, national systems, regional systems, and international institutions.

### Failure Codes and Verification Outcomes

In certain embodiments, the Time Sync API, BEIMINT conditioned issuance module, Behavioral Proof verifier, privacy module, entropy anti-spoofing module, Time Wallet, TimeVault, and TimeNodes may output machine-readable failure codes and verification outcomes. Such codes may be stored in a wallet record, synchronization record, audit record, mint certificate, masked audit state, verification response, or TimeNode state to support deterministic validation, retry, rejection, masking, or audit routing.

Non-limiting failure codes may include TIME_ANCHOR FAIL when a Time-of-Time Anchor is absent, stale, inconsistent, outside an applicable time window, or unsupported by a source attestation; BEHAVIOR_VECTOR_LOW_CONFIDENCE when a Behavior Vector fails a confidence threshold, sampling-window rule, noise filter, time-window alignment, or vectorization policy; and IDENTITY_CONTEXT_MISMATCH when a BID, DID, ReadName, TimeID, domain-linked identifier, non-domain identifier, wallet, device, credential, or attestation does not match the applicable identity context.

Additional non-limiting failure codes may include NONCE_REUSED when a nonce, counter, epoch identifier, prior state, or replay-prevention value has already been consumed; ENTROPY SPOOF RISK when the entropy anti-spoofing module detects replayed behavior, AI-generated behavior, duplicate issuance, anomalous behavior density, inconsistent location, inconsistent device context, or inconsistent service context; and PRIVACY_PROOF_INVALID when a privacy filter, masked commitment, selective disclosure, or zero-knowledge proof fails to verify an occurrence, validity, credential, role, policy, or confidence predicate.

Additional non-limiting failure codes may include TIMENODE_SYNC_CONFLICT when two or more TimeNodes report inconsistent signature commitments, wallet states, synchronization receipts, nonce states, audit hashes, or verification states; POLICY_SCOPE_FAIL when a claimed event is not eligible under a policy version, service category, jurisdictional scope, institutional rule, or privacy scope; and WALLET_STATE_INVALID when a Time Wallet or TimeVault record is revoked, expired, masked, disputed, archived, or lacks sufficient permission for the requested verification, transfer, index, exchange, licensing, or asset-package operation.

Non-limiting verification outcomes may include VERIFIED, VERIFIED_MASKED, PARTIALLY_VERIFIED, ISSUANCE_PENDING, ISSUANCE_REJECTED, SYNC_PENDING, SYNC_CONFLICT, AUDIT_REQUIRED, REVOKED, MASKED, ARCHIVED, EXPIRED, and NOT_AUTHORIZED. A verification outcome may include a confidence score, masking state, permitted disclosure level, retry instruction, audit reference, TimeNode receipt, or policy version reference.

In one embodiment, a VerifySignatureResponse returned by the Time Sync API includes {verificationStatus, failureCode, confidence, timeWindow, nodeProof, auditReference, maskingState, policy Version, retryState, syncState}. In another embodiment, a BEIMINT state record stores {priorState, requestedState, outcomeCode, failureCode, signatureRef, proofStatus, privacyStatus, entropyStatus, walletState, issuerNode, auditHash, policyReference}. These structures enable a skilled implementer to determine whether to issue, store, synchronize, index, exchange, license, mask, revoke, reject, retry, or route a time-certified digital asset for audit.

The foregoing failure codes and verification outcomes are illustrative and may be expanded, substituted, localized, grouped, or mapped to other machine-readable status codes without departing from the BEI Time-of-Time root architecture. The codes further support replay prevention, policy-bounded issuance, privacy-preserving verification, node synchronization, lifecycle enforcement, and deterministic audit of time-certified digital assets.

1. A computer-implemented Time of Time system for generating a BEI composite time signature and conditionally issuing a time-certified digital asset, comprising:
one or more processors;
a Time-of-Time Anchor module configured to assign a temporal anchor to a time event;
a BEI signal fusion engine configured to receive and normalize biometric, behavioral, contextual, device-based, location-based, communication-session, service-event, or institutional proof signals into a Behavior Vector;
an identity context generator configured to generate an Identity/Domain/Identifier Context associated with BID, DID, ReadName, TimeID, a domain-linked identifier, or a non-domain identifier;
a BEI composite time signature generator configured to generate a BEI Composite Time Signature by cryptographically binding at least the Time-of-Time Anchor, the Behavior Vector, the Identity/Domain/Identifier Context, a proof attestation, and a nonce;
a behavioral proof verifier configured to determine whether the BEI Composite Time Signature satisfies a behavioral proof condition;
a privacy and anti-spoofing module configured to apply privacy filtering, zero-knowledge verification, and entropy-based anti-spoofing;
a BEIMINT conditioned issuance module configured to generate, update, transfer, or accumulate the time-certified digital asset only after successful verification;
a Time Wallet or TimeVault storage node configured to store the time-certified digital asset with metadata linked to the BEI Composite Time Signature; and
a Time Sync API configured to synchronize or verify the BEI Composite Time Signature or the time-certified digital asset through one or more TimeNodes.

2. The system of claim 1, wherein the signals include at least one of a biometric signal, behavioral sequence, contextual signal, device telemetry signal, geolocation signal, communication-session signal, service-event signal, health-service signal, care-service signal, learning-event signal, labor-event signal, institutional proof signal, or contribution-event signal.

3. The system of claim 1, wherein the BEI signal fusion engine normalizes the received signals using a sampling window, noise filter, time-window alignment, duplicate-removal process, confidence score, or vectorization process to produce the Behavior Vector.

4. The system of claim 1, wherein the BEI Composite Time Signature is generated according to a hash of at least the Time-of-Time Anchor, the Behavior Vector, the Identity/Domain/Identifier Context, the proof attestation, and the nonce.

5. The system of claim 1, wherein the non-domain identifier includes at least one of a decentralized identifier, public key, wallet address, blockchain address, smart contract address, verifiable credential reference, hardware security module identifier, trusted execution environment attestation report, OIDC identifier, secure element identifier, QR code, NFC tag, edge-computing node identifier, or offline key.

6. The system of claim 1, wherein the behavioral proof condition includes a SceneKey generated from at least a time context, behavior context, environmental context, device context, location context, identity context, service context, or institutional proof context.

7. The system of claim 1, wherein the BEI Composite Time Signature includes or references a behavioral echo hash derived from passive biometric traces, behavioral sequences, contextual signals, or identity-linked scene data.

8. The system of claim 1, wherein the entropy-based anti-spoofing detects at least one of AI-generated behavior, replayed behavior, duplicate issuance, inconsistent device context, inconsistent location context, reused nonce, or anomalous behavior density.

9. The system of claim 1, wherein the privacy filtering or zero-knowledge verification verifies occurrence or validity of the time event without exposing raw personal, biometric, behavioral, emotional, health, or service-event content.

10. The system of claim 1, wherein the BEIMINT conditioned issuance module transitions an issuance record through at least Unverified, Time-Anchored, Behavior-Verified, Privacy-Verified, Time-Certified, Issued, Stored, or Synchronized states.

11. A computer-implemented method for generating a BEI composite time signature and conditionally issuing a time-certified digital asset, comprising: receiving signals through a BEI signal fusion engine; normalizing the signals into a Behavior Vector; assigning a Time-of-Time Anchor to a time event; generating an Identity/Domain/Identifier Context; computing a BEI Composite Time Signature by cryptographically binding the Time-of-Time Anchor, the Behavior Vector, the Identity/Domain/Identifier Context, a proof attestation, and a nonce; verifying a behavioral proof condition; applying privacy filtering, zero-knowledge verification, and entropy-based anti-spoofing; conditionally issuing the time-certified digital asset after successful verification; storing the time-certified digital asset in a Time Wallet or TimeVault; and synchronizing or verifying the BEI Composite Time Signature or the time-certified digital asset through a Time Sync API and one or more TimeNodes.

12. The method of claim 11, further comprising storing asset metadata including at least one of an asset identifier, owner identifier, Time Signature reference, wallet address, usage category, service type, lifecycle state, rights metadata, contribution score, privacy state, or synchronization state.

13. The method of claim 11, further comprising generating, updating, transferring, or accumulating the time-certified digital asset based on fractional time intervals, continuous time events, resource usage, service usage, care time, learning time, labor time, health time, communication time, or contribution time.

14. The method of claim 11, further comprising storing, by the Time Wallet or TimeVault, lifecycle metadata, beneficiary permissions, inheritance permissions, legacy-transfer rules, multi-signature attestation rules, time-decay access-control rules, or category-conversion metadata.

15. The method of claim 11, further comprising receiving, through the Time Sync API, a third-party verification request and returning a verification status based on the BEI Composite Time Signature, a masked audit record, or a TimeNode synchronization state.

16. The method of claim 11, further comprising synchronizing the BEI Composite Time Signature or the time-certified digital asset across a plurality of TimeNodes configured for cross-node verification, audit, replication, nonce checking, conflict detection, or privacy enforcement.

17. The method of claim 11, further comprising providing an optional index output comprising at least one of a TimeIndex, BEIIndex, BEIIDX, BIIDX, contribution score, identity score, behavior score, frequency score, or time-value index.

18. The method of claim 11, further comprising validating the time-certified digital asset through an optional exchange, licensing, wallet, institutional, service, or asset-package endpoint before transfer, authorization, listing, indexing, or licensing.

19. A non-transitory computer-readable medium storing instructions that, when executed by one or more processors, cause the one or more processors to: receive signals through a BEI signal fusion engine; normalize the signals into a Behavior Vector; assign a Time-of-Time Anchor to a time event; generate an Identity/Domain/Identifier Context; generate a BEI Composite Time Signature by cryptographically binding the Time-of-Time Anchor, the Behavior Vector, the Identity/Domain/Identifier Context, a proof attestation, and a nonce; verify the BEI Composite Time Signature using behavioral proof, privacy filtering, zero-knowledge verification, or entropy-based anti-spoofing; conditionally issue, update, transfer, or accumulate a time-certified digital asset; store metadata associated with the time-certified digital asset in a Time Wallet or TimeVault; and synchronize or verify the BEI Composite Time Signature or the time-certified digital asset through a Time Sync API and one or more TimeNodes.

20. The non-transitory computer-readable medium of claim 19, wherein the instructions further cause the one or more processors to maintain a masked audit record that verifies occurrence of a time event within a time interval without exposing masked personal, biometric, behavioral, emotional, health, or service-event content.
